(19) United States
(12) Patent Application Publication
(10) Pub. No.: US 2012/0213886 A1
(43) Pub. Date: Aug. 23, 2012

(54) Compositions and Methods to Lower Glycohemoglobin Levels

(75) Inventors: Mary C. Gannon, Eagan, MN (US); Frank Q. Nuttall, Eagan, MN (US)

(73) Assignees: U.S. Dept. of Veterans Affairs, Washington, DC (US); Regents of the Univ. of Minnesota, St. Paul, MN (US)

(21) Appl. No.: 13/401,218

(22) Filed: Feb. 21, 2012

Related U.S. Application Data
(63) Continuation-in-part of application No. 11/660,682, filed on Feb. 21, 2007, now Pat. No. 8,142,809.
(60) Provisional application No. 60/604,271, filed on Aug. 25, 2004.
(60) Provisional application No. 61/457,964, filed on Jul. 21, 2011.

(51) Int. Cl. A23L 1/29

(52) U.S. Cl. 426/2

(57) ABSTRACT

The invention provides for a diet that significantly reduces the glycohemoglobin levels in individuals with type 2 diabetes. A diet plan can be provided to an individual in the form of cards and/or pages with an appropriate meal plan, food items and/or pre-packaged meals, or in an electronic medium for the individuals to use to develop appropriate meal plans. The diet comprises food items having a nutritional composition that consists essentially of 30% protein, 50% fats, and 20% carbohydrates, or food items having a nutritional composition that consists essentially of 30% protein, 40% fats, and 30% carbohydrates, and is consumed for a period of three weeks to one year.

### CROSS-REFERENCE TO RELATED APPLICATIONS

This is a continuation-in-part (CIP) application of U.S. application Ser. No. 11/660,682, filed Feb. 21, 2007, which claims the priority benefit of U.S. Provisional Patent Application Ser. No. 60/604,271, filed Aug. 25, 2004, and International Application PCT/US2005/030483, filed Aug. 25, 2005, all hereby incorporated herein in their entirety by reference. This application further claims the priority benefit of U.S. Provisional Patent Application Ser. No. 61/457,964, filed Jul. 21, 2011, which is also hereby incorporated herein in its entirety by reference.

### TECHNICAL FIELD

This invention relates to glycohemoglobin levels, and more particularly to a compositions and methods to lower glycohemoglobin levels.

### BACKGROUND

The glucose absorbed following the ingestion of glucose-containing foods is largely responsible for a rise in the circulating glucose concentration. Dietary proteins, fats, and absorbed fructose and galactose resulting from the digestion of sucrose and lactose, respectively, have little effect on blood glucose concentration. Even short-term starvation (hours) results in a dramatic decrease in the blood glucose concentration in people with type 2 diabetes, which appears to be due largely to a rapid, progressive decrease in the rate of glycogenolysis.

Our interest over the past several years has been to determine, in people with type 2 diabetes, the metabolic consequences following ingestion of diets that are lower in carbohydrate and higher in protein than those recommended by government and professional organizations for the general population.

We previously had shown that the increase in blood glucose concentration following a meal is due largely to diet-derived glucose. This includes glucose per se, and that from the hydrolysis of the disaccharides sucrose and lactose. However, it is derived mainly from the hydrolysis of dietary starch. The other monosaccharides important in human nutrition, fructose and galactose, had little effect on the blood glucose concentration (References 1 and 2). We also had shown previously that dietary protein stimulates insulin secretion and either has no effect on blood glucose, or lowers it (References 3-7).

Since dietary glucose is largely responsible for raising the plasma glucose after a meal, and dietary protein either does not increase the glucose concentration, and indeed may lower it, we have designed diets we refer to as Low Biologically Available Glucose (LoBAG) diets. In these diets we have reduced the carbohydrate content, (particularly, starchy foods) and increased the protein content. The LoBAG diets have been classified according to the percent of total energy as carbohydrate using a subscript notation. Thus, a 20% carbohydrate diet is referred to as LoBAG₂₀, a 30% carbohydrate diet as LoBAG₃₀, and a 40% carbohydrate diet is referred to as LoBAG₄₀. The protein content in all of the above diets is 30% of food energy, i.e. the protein content is 1½-2 fold higher than that in a typical western diet.

All of these diets lowered the integrated 24-hour glucose concentration and resulted in a significant decrease in glycated hemoglobin (References 8-10).

Our previous studies were designed to be 5 weeks in length because this is the time reported for the glycated hemoglobin (GHb) to decrease by 50% of the ultimate value (t_{1/2}=33 days) (Reference 11) if the plasma glucose concentration is rapidly decreased and is maintained at a lower steady state. The new steady state occurs at ˜100 days, the time required for turnover of the red blood cell mass.

It is noted that glycated hemoglobin data in this application are referred to as both total glycohemoglobin (tGHb) and hemoglobin A1c (HbA1c). The designation refers to two different methods of determination. In our earlier studies, we measured glycated hemoglobin by boronate-affinity High Performance Liquid Chromatography (HPLC). Those data are reported as total glycated hemoglobin (tGHb). During the period of these studies our laboratory changed methods, and now uses an ion exchange HPLC method. Those data are reported as HbA1c. The results are similar.

### SUMMARY

The invention provides for diets that significantly reduce the glycohemoglobin levels in individuals with type 2 diabetes. The diets can be provided to an individual in the form of cards and/or pages with an appropriate meal plan, food items and/or pre-packaged meals, or in an electronic medium for the individuals to use to develop appropriate meal plans. For example, one diet comprises food items having a nutritional composition that consists essentially of 30% protein, 50% fats, and 20% carbohydrates, while another diet comprises food items having a nutritional composition that consists essentially of 30% protein, 40% fats, and 30% carbohydrates.

In one aspect, the invention provides an article of manufacture that includes food items for a single meal or snack, for a single day, or for multiple days. In one embodiment of the invention, the food items have a nutritional composition that consists essentially of 30% protein, 50% fats, and 20% carbohydrates. Usually, the fats consist essentially of 10% saturated fats and 40% mono- and poly-unsaturated fats. In another embodiment, the food items have a nutritional composition that consists essentially of 30% protein, 40% fats, and 30% carbohydrates.

Generally, the food items can be breakfast food items, lunch food items, dinner food items, and/or snack food items. In some embodiments, the food items can be in a pre-packaged meal. Typically, the caloric value of the sum of the food items essentially equals the daily-recommended caloric intake for an individual. According to the invention, ingestion of such food items, for a period of about 3 weeks to one year, preferably 5 weeks to 15 weeks, and more preferably 5 to 10 weeks, by an individual having elevated glycohemoglobin levels, decreases glycohemoglobin levels in the individual. Such a decrease can be statistically significant. The consumption of food items of the invention in this manner also resulted in a statistically significant decrease in fasting and/or random glucose level.

In another aspect, the invention provides an article of manufacture that includes food items for multiple days. In one embodiment of the invention, a portion of the food items have a nutritional composition that consists essentially of 30% protein, 50% fats, and 20% carbohydrates and another portion of the food items have a nutritional composition that consists essentially of 30% protein, 40% fats, and 30% carbohydrates. This combination of diets can be further combined with food items that have a nutritional composition that consists essentially of 30% protein, 30% fats, and 40% carbohydrates. Alternatively, a portion of the food items have a nutritional composition that consists essentially of 30% protein, 30% fats, and 40% carbohydrates while a portion of the food items have a nutritional composition that consists essentially of 30% protein, 50% fats, and 20% carbohydrates. As another alternative, a portion of the food items have a nutritional composition that consists essentially of 30% protein, 30% fats, and 40% carbohydrates while a portion of the food items have a nutritional composition that consists essentially of 30% protein, 40% fats, and 30% carbohydrates.

In another aspect, the invention provides methods of reducing the level of glycohemoglobin in an individual. Such a method can include providing an article of manufacture that includes food items for a single day that have a nutritional composition that consists essentially of 30% protein, 50% fats, and 20% carbohydrates, and instructing the individual to consume the food items. Such instructions can be provided online or as written instructions accompanying the article of manufacture. Included in such a method, or as a separate method of reducing the level of glycohemoglobin in an individual, an article of manufacture can be provided that includes food items for a single day that have a nutritional composition that consists essentially of 30% protein, 40% fats, and 30% carbohydrates along with the appropriate instructions.

In yet another aspect, the invention provides methods of developing a meal plan for an individual having type 2 diabetes. Such a method includes providing the daily-recommended caloric intake for an individual; and selecting food items for the individual based on the individual's daily-recommended caloric intake. In an embodiment of the invention, the food items have a nutritional composition that consists essentially of 30% protein, 50% fats, and 20% carbohydrates. In another embodiment of the invention, the food items have a nutritional composition that consists essentially of 30% protein, 40% fats, and 30% carbohydrates.

Using these steps, a meal plan can be developed for the individual. The embodiments described herein can be used in combination. For example, one, two, three, five, ten, or 15 weeks, or more of food items that have a nutritional composition that consists essentially of 30% protein, 50% fats, and 20% carbohydrates, followed by one, two, three, five, ten, or 15 weeks, or more, of food items that have a nutritional composition that consists essentially of 30% protein, 40% fats, and 30% carbohydrates.

According to the invention, ingestion of the food items does not result in ketosis in the individual, and results in maintenance of the individual's weight (i.e., does not result in the individual losing weight).

In still another aspect, the invention provides methods of developing a meal plan for an individual having type 2 diabetes. Such a method includes providing the daily-recommended caloric intake for an individual; and selecting food items for the individual based on the individual's daily-recommended caloric intake. In one embodiment of the invention, a portion of the food items have a nutritional composition that consists 30% protein, 50% fats, and 20% carbohydrates, and a portion of the food items have a nutritional composition that consists essentially of 30% protein, 40% fats, and 30% carbohydrates and/or 30% protein, 30% fats, and 40% carbohydrates. In another embodiment of the invention, a portion of the food items have a nutritional composition that consists essentially of 30% protein, 40% fats, and 30% carbohydrates, and a portion of the food items have a nutritional composition that includes 30% protein, 50% fats, and 20% carbohydrates and/or 30% protein, 30% fats, and 40% carbohydrates.

In yet another aspect, the invention provides a computer-readable storage medium having instructions stored thereon for causing a programmable processor to select a combination of food items for at least one day, wherein the food items collectively have a nutritional composition that consists essentially of 30% protein, 50% fats, and 20% carbohydrates or collectively have a nutritional composition that consists essentially of 30% protein, 40% fats, and 30% carbohydrates. The computer-readable storage medium, by instructing a programmable processor, can also select food items for individual meals, meals for a day or a number of days, or meals for one or more weeks that alternate or change between the two nutritional compositions set forth herein.

For example, a desired number of meals and snacks per day can be input into the processor; the weight and/or height of an individual can be input into the processor; the daily caloric intake of an individual can be input into the processor; and/or food item likes and/or dislikes can be input into the processor. The output is then the meal plans as described above. The output can be in any format including but not limited to print-outs, e-mails, and hyperlinks. The output can include a list of food item combinations for one or more meals or actual recipes for making such food items.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more preferred embodiments of the invention are set forth in the accompanying drawings and the description below. Other features, objects, and advantages of the invention will be apparent from the drawings and detailed description, and from the claims.

### DESCRIPTION OF DRAWINGS

One of the above and other aspects, novel features and advantages of the present invention will become apparent from the following detailed description of the non-limiting preferred embodiment(s) of invention, illustrated in the accompanying drawings, wherein:

FIG. 1 shows an example of instructions for a processor to determine meal plans using the Diet₂₀ of the invention.

FIG. 2 depicts graphs. FIG. 2A shows the mean body weight on while on the control (open circles) or test diet (closed circles). FIG. 2B shows the plasma beta-hydroxybutyrate concentration after 5 weeks on the control (open circles) or test diet (closed circles).

FIG. 3 depicts graphs. FIG. 3A shows the mean plasma glucose concentration before (open triangles) and after (open circles) 5 weeks on the control diet. Insert: Net and total 24 hour integrated glucose area response. Area response was not significantly different. FIG. 3B shows the mean plasma glucose concentration before (closed triangles) and after (closed circles) 5 weeks on the test diet. Insert: Net and total 24 hour integrated glucose area response. Both the net and total area responses were significantly lower after the test diet (p≦0.05).

FIG. 4 depicts graphs. FIG. 4A shows the mean serum insulin concentration before (open triangles) and after (open circles) 5 weeks on the control diet. Insert: Net and total 24 hour integrated insulin area response. Area response was not significantly different. FIG. 4B shows the mean serum insulin concentration before (closed triangles) and after (closed circles) 5 weeks on the test diet. Insert: Net and total 24 hour integrated insulin area response. Both the net and total area responses were significantly lower after the test diet (p≦0.05).

FIG. 5 shows the mean total glycohemoglobin response during the 5 weeks of the control (open circles) or test diet (closed circles). The tGHb on the test diet was significantly lower at weeks 3, 4, and 5 compared to the control diet (p≦0.05).

FIG. 6 depicts graphs. FIG. 6A shows the mean plasma glucagon concentration before (open triangles) and after (open circles) 5 weeks on the control diet. Insert: Net and total 24 hour integrated glucagon area response. Area response was not significantly different. FIG. 6B shows the mean plasma glucagon concentration before (closed triangles) and after (closed circles) 5 weeks on the test diet. Insert: Net and total 24 hour integrated glucagon area response. The net and total area responses were significantly higher after the test diet (p≦0.05).

FIG. 7 depicts graphs. FIG. 7A shows the mean serum triacylglycerol concentration before (open triangles) and after (open circles) 5 weeks on the control diet. Insert: Net and total 24 hour integrated triacylglycerol area response. Area response was not significantly different. FIG. 7B shows the mean serum triacylglycerol concentration before (closed triangles) and after (closed circles) 5 weeks on the test diet. Insert: Net and total 24 hour integrated triacylglycerol area response. The total area response was significantly lower after the test diet (p≦0.05).

FIG. 8 depicts a graph of body weight on a LoBAG diet. The mean±SEM of the body weight of 8 subjects who ingested a LoBAG₃₀ diet for 10 weeks. Figure indicates weight stability.

FIG. 9 depicts a bar chart of fasting plasma glucose concentration. The mean±SEM of the plasma glucose concentration of 8 subjects at baseline, while ingesting a standard diet, or after 5 weeks or after 10 weeks on a LoBAG₃₀ diet. The difference between Baseline and 5 weeks, Baseline and 10 weeks, and 5 weeks and 10 weeks were all statistically significant (P≦0.05), indicating that following a LoBAG diet for 10 weeks was even more effective in lowering the plasma (blood) glucose than following the diet for 5 weeks.

FIG. 10 depicts a graph of random (non-fasting) glucose concentration. The mean±SEM of the randomly obtained finger-stick glucose concentrations of 8 subjects who ingested a LoBAG₃₀ diet. The data indicate that following a LoBAG diet for 10 weeks resulted in a decrease in the non-fasting glucose concentration as well as the fasting glucose concentration. This is confirmed by the linear decrease in % tGHb (FIG. 14).

FIG. 11 depicts a graph of plasma glucose time course. The mean±SEM of the plasma glucose response of 8 subjects over a 24 hour period at baseline, while ingesting a control diet of 55% carbohydrate, 15% protein, 30% fat (open circles, broken line), 5 weeks after ingesting a LoBAG₃₀ diet consisting of 30% carbohydrate, 30% protein, 40% fat (closed circles, solid line) and 10 weeks after ingesting a LoBAG₃₀ diet (closed triangles, solid line). The letters on the x axis indicate time of ingestion of Breakfast, Lunch, Dinner, and Snack. These data are used to quantify the glucose area response (shown in FIGS. 12 & 13).

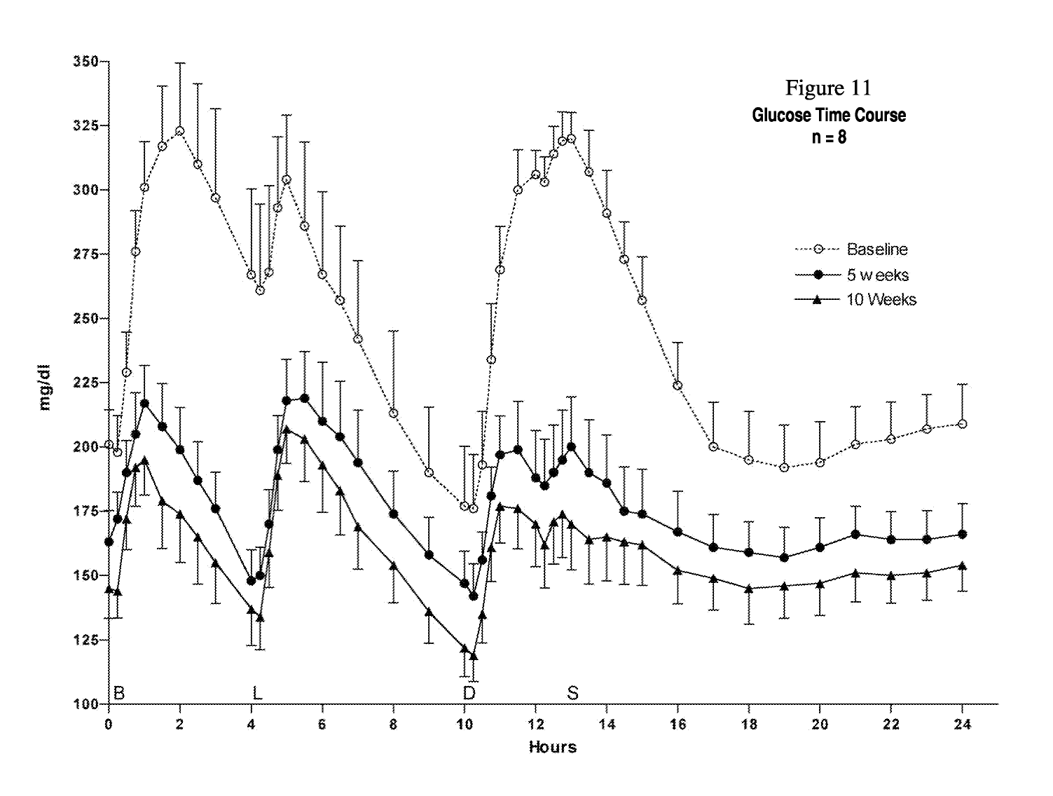

FIG. 12 depicts a bar chart of net glucose area. The mean±SEM of the area under the 24 hour glucose response curve for 8 subjects, using the fasting (0800 hr) glucose concentration as baseline. The 5 and 10 week areas are statistically significantly less than the baseline value, but not different from one another, indicating that following a LoBAG diet for 10 weeks results in an improvement in postprandial glucose concentrations similar to that observed at 5 weeks.

FIG. 13 is a bar chart of total glucose area. The mean±SEM of the area under the 24-hour glucose response curve for 8 subjects using a glucose concentration of zero as baseline. The 5 and 10-week total areas are statistically significantly less than the baseline value, and also from one another, indicating that following a LoBAG diet for 10 weeks results in an improvement in 24 hour integrated glucose concentration that is further improved compared to that observed at 5 weeks.

FIG. 14 depicts a graph of % glycated hemoglobin (total glycohemoglobin or % tGHb). The mean±SEM of the % glycated hemoglobin for 8 subjects ingesting a LoBAG₃₀ diet for 10 weeks. The decrease was highly significant, both clinically and statistically. The decrease also was linear, which was not predicted by the literature, indicating that a metabolic adaptation has occurred in the individuals on a LoBAG diet.

FIG. 15 depicts a graph of serum insulin time course. The mean serum insulin response of 8 subjects over a 24-hour period at baseline, while ingesting a control diet of 55% carbohydrate, 15% protein, 30% fat (open circles, broken line), 5 weeks after ingesting a LoBAG₃₀ diet consisting of 30% carbohydrate, 30% protein, 40% fat (closed circles, solid line) and 10 weeks after ingesting a LoBAG₃₀ diet (closed triangles, solid line). The letters on the x axis indicate time of ingestion of Breakfast, Lunch, Dinner, and Snack. There was no difference in insulin response between baseline and after following the LoBAG diet for 5 or 10 weeks which indicates that the improvement in plasma glucose was due to an improvement in insulin sensitivity, not to a change in circulating insulin concentration.

FIG. 16 depicts a bar chart of fasting triacylglycerol concentration. The mean±SEM of the fasting serum triacylglycerol concentration of 8 subjects at baseline while ingesting a standard diet, or after 5 weeks or after 10 weeks on a LoBAG₃₀ diet. The decreases at 5 and 10 weeks are statistically significantly different from baseline, but not from one another. This indicates that a LoBAG diet does not have deleterious effects on the circulating fat in the blood.

FIG. 17 depicts a graph of serum triacylglycerol time course. The mean serum triacylglycerol response of 8 subjects over a 24-hour period at baseline, while ingesting a control diet of 55% carbohydrate, 15% protein, 30% fat (open circles), 5 weeks after ingesting a LoBAG₃₀ diet consisting of 30% carbohydrate, 30% protein, 40% fat (closed circles) and 10 weeks after ingesting a LoBAG₃₀ diet (closed triangles). The letters on the x axis indicate time of ingestion of Breakfast, Lunch, Dinner, and Snack. Using these data it was calculated that the net triacylglycerol area responses were nearly identical. The total area responses decreased and approached statistical significance (P=0.06) (data not shown). These data demonstrate that lowering the carbohydrate content of the diet also lowers the 24-hour integrated triacylglycerol concentration.

FIG. 18 depicts a graph of plasma glucagon time course. The mean plasma glucagon response of 8 subjects over a 24 hour period at baseline, while ingesting a control diet of 55% carbohydrate, 15% protein, 30% fat (open circles), 5 weeks after ingesting a LoBAG₃₀ diet consisting of 30% carbohydrate, 30% protein, 40% fat (closed circles) and 10 weeks after ingesting a LoBAG₃₀ diet (closed triangles). The letters on the x axis indicate time of ingestion of Breakfast, Lunch, Dinner, and Snack. Although the net glucagon area responses increased progressively from baseline to 5 weeks and to 10 weeks, the increases were not significant. The total area responses were similar (data not shown). Thus, in spite of a modest increase in postprandial glucagon, the glucose responses at 5 weeks and 10 weeks were decreased. (Increases in glucagon are thought to result in an increase in glucose production but we have not been able to document this in our laboratory with modest increases in glucagon.)

FIG. 19 depicts a graph of serum non-esterified fatty acid (NEFA) time course. The mean serum NEFA response of 8 subjects over a 24 hour period at baseline, while ingesting a control diet of 55% carbohydrate, 15% protein, 30% fat (open circles), 5 weeks after ingesting a LoBAG₃₀ diet consisting of 30% carbohydrate, 30% protein, 40% fat (closed circles) and 10 weeks after ingesting a LoBAG₃₀ diet (closed triangles). The letters on the x axis indicate time of ingestion of Breakfast, Lunch, Dinner, and Snack. Neither the net nor the total area responses were significantly different (data not shown). Thus, in spite of the higher fat content of the LoBAG₃₀ diet, the NEFA concentrations did not change.

FIG. 20 depicts a graph of relationship between insulin and NEFA responses. The mean serum insulin response (closed triangles) of 8 subjects compared to the NEFA response (open circles) over a 24 hour period while ingesting a control diet of 55% carbohydrate, 15% protein, 30% fat.

FIG. 21 depicts a graph of relationship between insulin and NEFA responses. The mean serum insulin response (closed triangles) of 8 subjects compared to the NEFA response (open circles) over a 24 hour period following 5 weeks of ingesting a LoBAG 30 diet consisting of 30% carbohydrate, 30% protein, 40% fat.

FIG. 22 depicts a graph of relationship between insulin and NEFA responses. The mean serum insulin response (closed triangles) of 8 subjects compared to the NEFA response (open circles) over a 24 hour period following 10 weeks of ingesting a LoBAG 30 diet consisting of 30% carbohydrate, 30% protein, 40% fat.

FIG. 23 depicts a graph of serum total alpha amino acid nitrogen (AAN) time course. The mean serum AAN response of 8 subjects over a 24 hour period at baseline, while ingesting a control diet of 55% carbohydrate, 15% protein, 30% fat (open circles, broken line), 5 weeks after ingesting a LoBAG₃₀ diet consisting of 30% carbohydrate, 30% protein, 40% fat (closed circles, solid line) and 10 weeks after ingesting a LoBAG₃₀ diet (closed triangles, solid line). The letters on the x axis indicate time of ingestion of Breakfast, Lunch, Dinner, and Snack. These data are used to quantify the AAN area responses, shown in FIGS. 24 and 25.

FIG. 24 depicts a bar chart of net AAN area. The mean±SEM of the net area under the 24-hour AAN response curve for 8 subjects using the fasting AAN concentration as baseline. The 5 and 10-week net areas are statistically significantly greater than the baseline value, but not from one another, indicating that following a LoBAG diet for 5-10 weeks results in an improvement in the net 24 hour integrated AAN concentration, i.e., the postprandial concentrations are increased.

FIG. 25 depicts a bar chart of total AAN area. The mean±SEM of the area under the 24-hour AAN response curve for 8 subjects using an AAN concentration of zero as baseline. The 5 and 10-week total areas are statistically significantly greater than the baseline value, but not from one another, indicating that following a LoBAG diet for 5-10 weeks results in an improvement in 24 hour integrated AAN concentration, i.e. the total 24 hour concentrations are increased. This is important because the increased amino acids then are available for new protein synthesis. This, in addition to the increase in IGF-I (FIG. 31), could result in an increase in muscle mass, which then would help ameliorate the weakness and frailty of aging.

FIG. 26 depicts a graph of serum uric acid time course. The mean serum uric acid response of 8 subjects over a 24 hour period at baseline, while ingesting a control diet of 55% carbohydrate, 15% protein, 30% fat (open circles), 5 weeks after ingesting a LoBAG₃₀ diet consisting of 30% carbohydrate, 30% protein, 40% fat (closed circles) and 10 weeks after ingesting a LoBAG₃₀ diet (closed triangles). The letters on the x axis indicate time of ingestion of Breakfast, Lunch, Dinner, and Snack. There was no change in net or total uric acid area response. These data indicate that although a LoBAG₃₀ diet is higher in protein than a standard diet, an increase in uric acid, a risk factor for gout, is not increased.

FIG. 27 depicts a graph of plasma urea nitrogen time course. The mean plasma urea nitrogen response of 8 subjects over a 24 hour period at baseline, while ingesting a control diet of 55% carbohydrate, 15% protein, 30% fat (open circles), 5 weeks after ingesting a LoBAG₃₀ diet consisting of 30% carbohydrate, 30% protein, 40% fat (closed circles) and 10 weeks after ingesting a LoBAG₃₀ diet (closed triangles). The letters on the x axis indicate time of ingestion of Breakfast, Lunch, Dinner, and Snack.

FIG. 28 depicts a bar chart of total urea nitrogen area. The mean±SEM of the area under the 24-hour urea nitrogen response curve for 8 subjects using a urea nitrogen concentration of zero as baseline. The 5 and 10-week total areas are statistically significantly greater than the baseline value, but not from one another. The increase was not two fold, as may be expected with doubling of the protein content of the diet. These data indicate that following a LoBAG₃₀ diet for an additional 5 weeks does not result in further increase in 24 hour integrated urea nitrogen concentration, i.e. a new steady state appears to have been reached by 5 weeks. This is supported by the urinary urea nitrogen excretion (Table 9), which indicates that the urea nitrogen excretion actually was statistically significantly less at week 10 than at week 5.

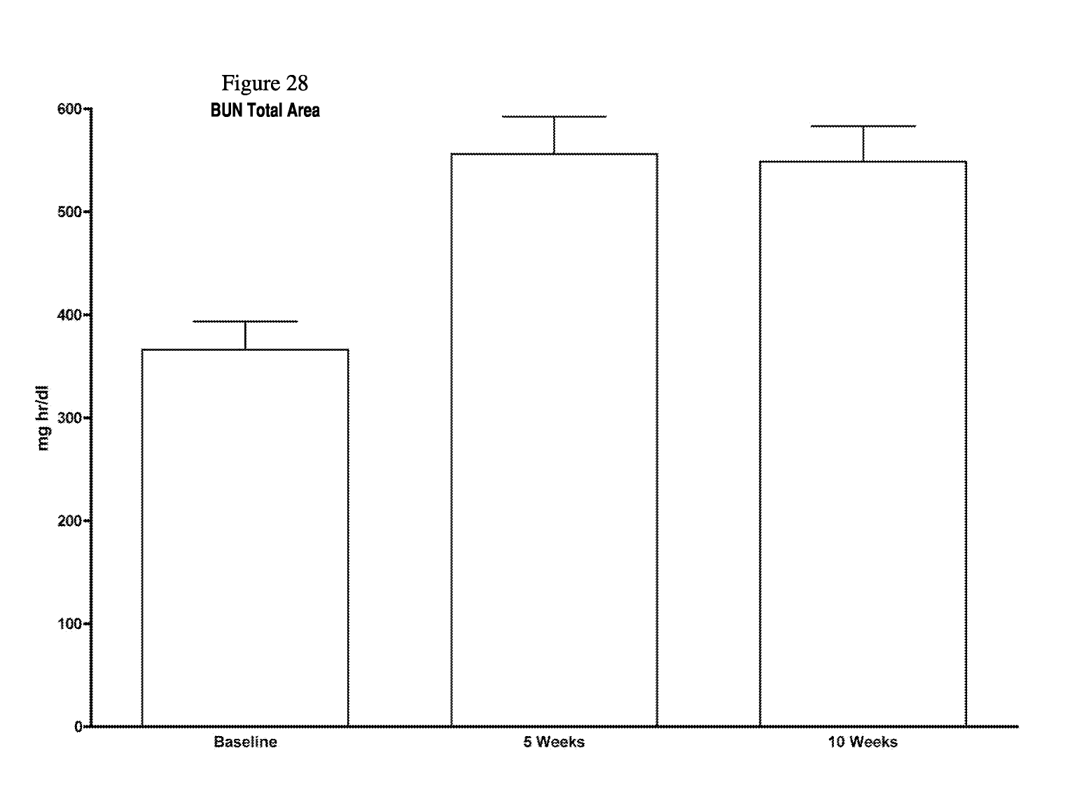

FIG. 29 depicts a bar chart of amount of protein ingested. The mean±SEM of the total amount of protein ingested by 8 subjects during the time that blood was drawn and urine was collected at baseline, while ingesting a 55% carbohydrate, 15% protein, 30% fat diet, and at 5 weeks and 10 weeks, while ingesting a 30% carbohydrate, 30% protein, 40% fat diet. These data indicate that based on the calculations of the food composition, a LoBAG₃₀ diet resulted in an increased amount of protein ingested.

FIG. 30 depicts a bar chart of percent of protein metabolized. The mean±SEM of the percent of protein metabolized by 8 subjects during the time that blood was drawn and urine was collected at baseline, while ingesting a 55% carbohydrate, 15% protein, 30% fat diet, and at 5 weeks and 10 weeks, while ingesting a 30% carbohydrate, 30% protein, 40% fat diet. These data indicate that the percent of protein metabolized, i.e. accounted for the breakdown products excreted, was less following ingestion of a LoBAG₃₀ diet. The data strongly suggest a large proportion of the protein ingested was maintained, and thus the metabolic components (amino acids) are available for use in synthesizing new body protein.

FIG. 31 depicts a bar chart of serum insulin-like-growth factor-I (IGF-I) concentration. The mean±SEM of the fasting serum IGF-I concentration of 8 subjects at baseline, while ingesting a 55% carbohydrate, 15% protein, 30% fat diet, and at 5 weeks and 10 weeks, while ingesting a 30% carbohydrate, 30% protein, 40% fat diet. The increase at 5 and 10 weeks was statistically increased compared to baseline. In addition, the 10-week value was significantly greater than the 5 week value (P=0.01). IGF-I stimulates protein synthesis. Thus, a LoBAG₃₀ diet could be beneficial in preventing loss of muscle mass in the aging population.

FIG. 32 depicts a bar chart of fasting serum cholesterol concentration. The mean±SEM of the fasting serum cholesterol concentration of 8 subjects at baseline while ingesting a standard diet, or after 5 weeks or after 10 weeks on a LoBAG₃₀ diet. Thus, although a LoBAG₃₀ diet contains 40% fat, the diet did not result in an increase in serum cholesterol.

FIG. 33 depicts a bar chart of urine pH. The mean±SEM pH of a 24-hour urine sample at baseline while subjects ingested a standard diet, or after 5 weeks or after 10 weeks on a LoBAG₃₀ diet. There was no difference in pH between samples obtained at baseline, 5 weeks or 10 weeks. This is important because it has been suggested that theoretically, a high protein diet will result in a decrease in urine pH (i.e. an increase in acidity), which theoretically could deplete bone calcium. Our data indicate this is not the case.

FIG. 34 depicts a bar chart of urinary calcium excretion. The mean±SEM of the amount of calcium excreted in the urine during a 24-hour period while subjects ingested a standard diet, or after 5 weeks or after 10 weeks on a LoBAG₃₀ diet. The calcium excretion actually decreased modestly, rather than increased, as had been suggested to occur with a high protein diet. Thus, calcium was not being leached from bone while following a LoBAG diet.

FIG. 35 depicts a bar chart of creatinine clearance. The mean±SEM of the creatinine clearance during a 24-hour period while subjects ingested a standard diet, or after 5 weeks or after 10 weeks on a LoBAG₃₀ diet. The creatinine clearance increased at 5 and 10 weeks compared to baseline, but following a LoBAG diet for 10 weeks had no further effect compared to the result at 5 weeks. These changes are within a normal range and indicate that a LoBAG diet did not impair kidney function.

FIG. 36 depicts a graph of decrease in glycated hemoglobin (HbA1c) at 15 weeks. The individual data for five subjects who were instructed to ingest a LoBAG₃₀ diet on an outpatient basis. All subjects were taking 2000 mg/day of metformin, a commonly prescribed diabetes medication. All subjects were within 5 pounds of their starting weight at week 15. The average decrease for the 5 subjects was 0.7, which is considered a clinically significant decrease.

FIG. 37 depicts a graph of decrease in % glycated hemoglobin (total glycohemoglobin or % tGHb) over one year. The decrease in % tGHb in one individual who consumed a LoBAG₃₀ diet for 1 year on his own. After having participated in the 10-week study, he received no further instruction or consultation from the study staff. After day 70 the subject was seen in clinic infrequently. His % tGHb was >11% at the beginning of the study. This is a very abnormally high value. After one year, during which time he received no diabetes medication, his % tGHb was at a normal level.

FIG. 38 depicts a bar chart of body weight. This figure indicates that body weight was stable in the individual whose % tGHb is shown in FIG. 22, indicating that the change in % tGHb from ˜11.5% at the beginning of the year to a normal value of 6.0% at the end of one year was not due to weight loss. The subject also was not taking any medication during this time for his type 2 diabetes.

FIG. 39 depicts a bar chart of fasting serum cholesterol. This figure indicates that fasting serum cholesterol was stable, or even decreased modestly in the individual whose % tGHb is shown in FIG. 22. Thus, although a LoBAG₃₀ diet contains 40% fat, the diet did not result in an increase in serum cholesterol. Indeed, a decrease was observed.

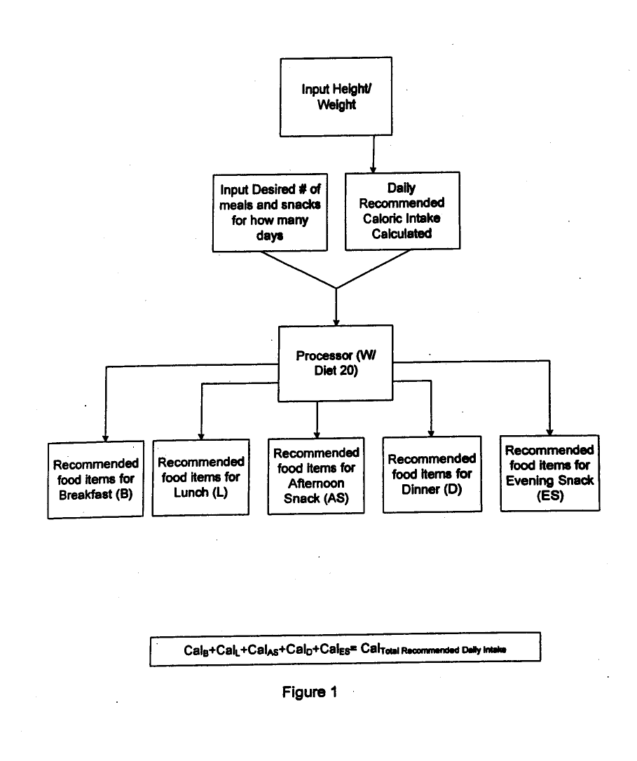

Like reference symbols in FIGS. 1-7 indicate like elements.

### DETAILED DESCRIPTION

To determine whether or not a diet low in food-derived glucose can lower both the fasting as well as the post-prandial blood glucose, a low carbohydrate diet was designed in which readily digestible starch-containing foods were de-emphasized. The carbohydrate content in the diet, however, was sufficient to prevent ketosis, which is in contrast to low-carbohydrate diets that are often advocated for weight loss. Glycohemoglobin, 24-hour glucose, insulin, C-peptide, beta-hydroxybutyrate, glucagon, triacylglycerol, and non-esterified fatty acids (NEFA) were examined to evaluate the effects of the diet on individuals with type 2 diabetes.

### Blood Glucose, Glycohemoglobin and Type II Diabetes

Blood glucose levels represent the amounts of sugars present in the blood at the time the blood is withdrawn. Blood glucose levels vary throughout the day and depend upon diet, exercise, and the level of insulin in the blood. Individuals can test their own blood glucose levels using, for example, a home monitor or a hand-held meter.

The % total glycohemoglobin and the % hemoglobin A_{1c} are two methods used to measure the glucose attached to hemoglobin. The % total glycohemoglobin used in this study is specific for the ketoamine adduct resulting from glucose attachment to primary amino groups on amino acids in the globin molecules in hemoglobin. Normally, only a small percentage of hemoglobin in the blood (˜4% to 6%) has glucose bound to it. People with diabetes (or other conditions that increase their blood glucose levels), however, have a higher % glycohemoglobin than normal. The % glycohemoglobin is considered to be an index of the average, i.e. 24-hour integrated blood glucose concentration over an extended period of time, that of the life of the red blood cell (weeks to months). Thus, the % glycohemoglobin level is considered to represent the average blood glucose concentration in the weeks and months preceding the test. The glycohemoglobin level does not exhibit rapid changes due to exercise, medications, or eating prior to the test.

Diabetes and some of the risks of developing complications caused therefrom have been associated with the % glycohemoglobin. Diabetes is a chronic disease that develops when either the pancreas cannot produce enough insulin or the body cannot use insulin properly. Insulin allows sugar (e.g., glucose) to enter cells, where it is used for energy. Insulin also helps the body store extra glucose in muscle, fat, and liver cells. Symptoms of diabetes include increased thirst and frequent urination; unexplained increase in appetite; unexplained weight loss; fatigue; erection problems; blurred vision; and tingling or numbness in hands or feet. Individuals with diabetes have an increased risk for many serious health problems including hardening of the arteries (atherosclerosis) and heart problems, eye problems than can lead to blindness, circulation and nerve problems; and kidney disease or kidney failure. Type 2 diabetes can develop at any age, although it usually develops in adults. Type 2 diabetes used to be called adult-onset diabetes, as well as non-insulin-dependent diabetes mellitus (NIDDM) because it can often be treated without using insulin.

### Diets Resulting in Low Biologically-Available Glucose

It has been determined and is described herein that an individuals' % glycohemoglobin level, plasma glucose level, serum insulin concentration, serum C-peptide concentration, and serum triacylglycerol level can be significantly reduced by following a diet that consists essentially of food items having a nutritional composition of approximately 30% protein, 50% fats, and 20% carbohydrate. This diet is referred to herein as “Diet₂₀.” Such levels also can be significantly reduced by following a diet that consists essentially of food items having a nutritional composition of approximately 30% protein, 40% fats, and 30% carbohydrate. This diet is referred to herein as “Diet₃₀.”

The desired nutritional composition described herein for Diet₂₀ or Diet₃₀ can be calculated for the meals in a single day, the meals in multiple days, the meals in one week, or longer. The diet of the invention usually uses the recommended daily caloric intake of an individual and the desired distribution of the food ingested in a day (e.g., the number of meals, and snacks, if desired) to determine the amount of food that should be ingested in each meal or snack in a day.

It may be impractical to achieve an exact percentage of each nutritional component in a food item, meal, or other diet constituent. It is understood by those of skill in the art that it is easier to calculate the desired nutritional composition in meals ingested over days or weeks than it is to calculate the desired nutritional composition over a single meal or the meals ingested in a single day. As such, it is to be understood that the percentage of components disclosed herein represents approximations attainable by a person of ordinary skill in the art using the nutritional guidelines provided herein for each diet. In addition, the diet provided herein may contain other components (e.g., nucleic acids, and/or medicaments) provided that these other components do not significantly alter the indicated nutritional composition of proteins, fats, and carbohydrates. This is what is meant by “consisting essentially of.”

The Diet₂₀ and Diet₃₀ disclosed herein result in a statistically significant reduction in, for example, an individual's glycohemoglobin levels. As used herein, “statistically significant” refers to a p-value of less than or equal to 0.05, e.g., a p-value of less than or equal to 0.025 or a p-value of less than or equal to 0.01, using an appropriate measure of statistical significance, e.g., a two-tailed paired t-test.

A meal plan appropriately calculated for an individual using the Diet₂₀ or the Diet₃₀ described herein can be provided to an individual in need of such a diet in the form of cards or pages. The cards or pages can provide a list of food items and appropriate suggestions for meal combinations using such food items. The cards or pages also can provide a meal plan (i.e., suggested combinations of food items and meals for a given day) that meets both the caloric intake and nutritional composition requirements over the desired number of days or weeks. Recommended serving size can be indicated, and recipes for some of the food items or meal combinations can be provided, if desired.

A meal plan appropriately calculated for an individual using the Diet₂₀ or the Diet₃₀ disclosed herein also can be provided to an individual in the form of actual food items or pre-packaged meals. Food items can be packaged separately and ingested individually or combined by the individual into meals. As indicated above, suggestions for a variety of meals using combinations of the food items and pre-packaged meals that essentially meet the nutritional composition of the Diet₂₀ or Diet₃₀ and the caloric intake and the eating preferences of the individual can be provided. Pre-packaged meals are well known in the art and are routinely used in many types of diets, particularly those for the purpose of weight management. For example, sufficient food items and/or pre-packaged meals for multiple days (e.g., 7 days worth) or for one or more weeks (e.g., 2 weeks worth, or 1 month worth) can be provided to an individual.

In addition to the Diet₂₀ and Diet₃₀ disclosed herein, additional diets are disclosed that allow for ingestion of more carbohydrates and fewer fats, but that also reduce glycohemoglobin levels in an individual with elevated levels. For example, “Diet₄₀” is a diet in which food items having a nutritional composition that consists essentially of 30% protein, 30% fats, and 40% carbohydrates. Diet₂₀, Diet₃₀, and Diet₄₀ can be used in conjunction with one another (e.g., repeating schedule of 3-5 weeks on Diet₂₀, 2-3 weeks on Diet₃₀, and 2-3 weeks on Diet₄₀) to lower or maintain an individual's glycohemoglobin levels while consistently providing the individual with palatable and digestible food items and meals. It is apparent to those of skill in this art that the diet regimen an individual follows (e.g., which diet and for how long) will depend, in part, on the individual's ability to manage glycohemoglobin levels and/or the progression of the diabetes, while still taking into account the lipid profile of the individual.

### Computer-Readable Medium for Implementing Diet₂₀ or Diet₃₀

In addition to the cards, pages, recipes, meal plans, food items, and/or pre-packaged meals discussed above, the Diet₂₀ or Diet₃₀ described herein can be provided to an individual in the form of a computer-readable medium that contains instructions for causing a programmable processor to generate a meal plan for an individual that follows the Diet₂₀ or Diet₃₀. For example, a computer-readable medium containing instructions for generating a meal plan according to Diet₂₀ or Diet₃₀ can be provided to an individual in the form of, without limitation, a floppy disk, a CD, or a DVD. In addition, a computer-readable medium of the invention can be accessed electronically using, for example, a dial-up or internet connection to download or use remotely. FIG. 1 shows a chart of a representative processing system that can be used with a computer-readable medium of the invention to generate a meal plan according to the Diet₂₀ disclosed herein.

Instructions carried on a computer-readable medium of the invention can be implemented in a high level procedural or object oriented programming language to communicate with a processor. Alternatively, such instructions can be implemented in assembly or machine language, which can be compiled or interpreted. A processor can be a computer such as a personal computer or workstation that executes program code. One or more input devices (e.g., a keyboard or a mouse) and one or more output devices (e.g., a printer or a monitor) can be used in addition to the processor.

For example, an individual (or a representative of the individual, e.g., a nurse, a nutritionist, a dietitian, etc.) can input the height (in inches and/or centimeters) and weight (in pounds and/or kilograms) of the individual. Age and gender also can be input, but are not necessary. The daily caloric intake can take into account an individual's activity level and/or weight goals, although neither the Diet₂₀ nor the Diet₃₀ described herein are intended for weight loss purposes. For example, individuals can indicate if they consider themselves to be sedentary, or to have minimal, moderate, or strenuous activity during the day, and whether they wish to maintain their weight, lose weight, or gain weight. From this information, an individual's recommended daily caloric intake can be determined. Alternatively, a desired daily caloric intake, if known, can be input directly.

The individual then can input the number of meals they wish to ingest in a day. Some individuals prefer to eat three meals a day, while others prefer to include snacks between one or more meals. The preference for the number of meals and snacks in a day can be used to determine the caloric distribution during the day.

The instructions contained on a computer-readable medium of the invention also can allow for a variety of specialized options. For example, individuals can select (or de-select) food items that the individual likes or dislikes, or cannot eat, for example, due to allergies, religious beliefs/practices, or adverse reactions with a medication. The instructions contained on a computer-readable medium of the invention can include a system of equivalents such that foods that are removed due to, for example, one of the previously-discussed reasons, can be substituted with food items having a similar caloric and nutritional value as the food removed. In addition, the instructions on the computer-readable medium can allow for input of the number of people for which a recipe will be prepared, the time frame for which the individual wants to spend preparing a food item, and/or a choice of the ethnicity of a food item or meal (e.g., Chinese, Italian, or Mexican).

As part of the invention, there is provided a database containing the nutritional composition of a variety of food items and meals. Such a database can be contained on the same or on a different computer-readable medium as the instructions for determining the Diet₂₀ or Diet₃₀ meal plan, or can be accessed and/or downloaded via, for example, an internet connection. The database provides a large number of food items and meals that can be mixed and matched in combination to result in a variety of meals and snacks having the appropriate nutritional composition and caloric values.

In accordance with the present invention, there may be employed conventional laboratory and/or clinical testing techniques within the skill of the art. Such techniques are explained fully in the literature. The invention will be further described in the following examples, which do not limit the scope of the invention described in the claims.

### EXAMPLES

### A. Diet₂₀

### Example 1

### Participants

Male subjects with mild, untreated type 2 diabetes were studied in a “Special Diagnostic and Treatment Unit” (SDTU), a facility similar to a Clinical Research Center. All subjects met the National Diabetes Data Group criteria for the diagnosis of type 2 diabetes mellitus (Report of the Expert Committee on the Diagnosis and Classification of Diabetes Mellitus: Diab. Care, 21:S5-S19 (Suppl 11), 1998). Subject characteristics are given in Table 1. The study was approved by the Department of Veterans Affairs Medical Center and the University of Minnesota Committees on Human Subjects and written informed consent was obtained from all subjects. The subjects did not have hematologic abnormalities, kidney disease, liver disease, macroalbuminuria (>300 mg/24 h), congestive heart failure, or untreated thyroid disease. Prior to the study, all subjects were interviewed to determine their physical activity profile, food aversions, and to explain the study process and commitment in detail. Subjects confirmed they had been weight stable for at least 3 months. They were instructed to maintain their current activity level throughout the study. Two weeks prior to beginning the study, the subjects completed a 3-day food frequency questionnaire with one of the days being a Saturday or Sunday. This information was used to calculate the total food energy necessary to maintain body weight. None of the subjects was being treated with oral hypoglycemic agents or insulin at the time they were enrolled in the study. A 5-week randomized, crossover study design was used with a 5-week washout period between diets.

TABLE 1
Patient characteristics

| | | Height | Weight | | | Duration | | |
|---|---|---|---|---|---|---|---|---|
| | Age | [inches | [pounds | BMI | tGHb | of diabetes | Concomitant | |
| Patient | (yrs) | (cm)] | (kg)] | (kg/m²) | (%) | (months) | diseases | Medications |
| 1 | 69 | 74 (188) | 221 (100) | 27 | 8.7 | 60 | hypertension, | simvastatin, |
| | | | | | | | dyslipidemia, | lisinopril, |
| | | | | | | | coronary | rabeprazole, |
| | | | | | | | heart disease | ASA |
| 2 | 72 | 69 (165) | 239 (109) | 35 | 10.0 | 12 | chronic | terazosin |
| | | | | | | | obstructive | |
| | | | | | | | pulmonary | |
| | | | | | | | disease | |
| 3 | 51 | 68 (173) | 181 (82) | 27 | 8.6 | 12 | none | ASA, |
| | | | | | | | | naproxen |
| 4 | 66 | 72 (183) | 196 (89) | 27 | 9.0 | 180 | hypertension | none |
| 5 | 82 | 71 (180) | 204 (93) | 28 | 11.2 | 48 | none | lisinopril, |
| | | | | | | | | ASA |
| 6 | 56 | 72 (183) | 267 (121) | 35 | 10.1 | 24 | obesity, | none |
| | | | | | | | dyslipidemia | |
| 7 | 51 | 66 (168) | 195 (89) | 31 | 10.0 | 14 | none | ASA, |
| | | | | | | | | naproxen |
| 8 | 59 | 67 (170) | 233 (106) | 36 | 9.4 | 19 | hypertension, | lisinopril |
| | | | | | | | obesity | |
| Mean | 63.3 | 70 (176) | 217 (99) | 31 | 9.6 | 46 | — | — |
| Range | 51-82 | 66-74 | 181-267 | 27-36 | 8.6-11.2 | 12-180 | — | — |
| | | (168-188) | (82-121) | | | | | |

ASA: Acetylsalicylic Acid

### Example 2

### Diet

The control diet was designed according to the recommendations of the American Heart Association (American Heart Association: Dietary guidelines for healthy American adults; a statement for physicians and health professionals by the Nutrition Committee, Circulation, 74:1465 A-1468A, 1986), and the United States Department of Agriculture (USDA: The food guide pyramid, Washington D.C., US Government Printing Office, 1992; USDA & US Department of Health and Human Services: Nutrition and your health: dietary guidelines for Americans, Washington D.C., US Government Printing Office, 1995). The control diet consisted of 55% carbohydrate, with an emphasis on starch-containing foods, 15% protein, and 30% fat (10% monounsaturated, 10% polyunsaturated, 10% saturated fatty acid content). The control diet is a diet that is recommended for the general population as a means of reducing one's risk for coronary heart disease.

The low-biologically-available-glucose diet (the “test” diet) was designed to have a nutritional composition that consists essentially of 30% protein, 50% fats, and 20% carbohydrate. The saturated fatty acid content of the test diet was ˜10% of total food energy, thus the majority of the fat was mono- and polyunsaturated fats. The nutritional composition of the control and test diets is given in Table 2, and Table 3 shows representative meals for the control and test diet.

TABLE 2
Composition of diets

| | Control Diet | Test Diet |
|---|---|---|
| Energy (kcal) | 2,825 | 2,825 |
| Protein [g (%)] | 106 (15) | 210 (30) |
| Carbohydrate [g (%)] | 388 (55) | 142 (20) |
| Monosaccharides (g) | 64 | 31 |
| Disaccharides (g) | 50 | 16 |
| Fat [g (%)] | 94 (30) | 158 (50) |
| Monounsaturated (g) | 29 | 62 |
| Polyunsaturated (g) | 24 | 35 |
| Saturated (g) | 33 | 30 |
| Cholesterol (mg) | 375 | 441 |
| Dietary fiber (g) | 24 | 36 |

TABLE 3
Sample Menu for One Day

| Control | | | Diet₂₀ | | |
|---|---|---|---|---|---|
| Breakfast | 57 | g (2 oz) Total Cereal | Breakfast | 124 | g (4 oz) Egg Substitute |
| | 50 | g (2 slice) Wheat Bread | | 23 | g Green Pepper |
| | 244 | g (1 Cup) 2% Milk | | 56 | g (2 oz) Cheddar Cheese |
| | 10 | g (2 tsp) Margarine | | 18 | g (1 slice) Tomato |
| | 10 | g (2 tsp) Jelly | | 131 | g (1) Fresh Orange |
| | 114 | g (1) Banana | | | |
| | 120 | g (4 oz) grape Jelly | | | |
| | 8 | g (2 tsp) Sugar | | | |
| Lunch | 50 | g (2 slices) Wheat Bread | Lunch | 226 | g (8 oz) Roasted Ham |
| | 85 | g (3 oz)Lean Ham | | 85 | g (3 oz) Swiss Cheese |
| | 5 | g (1 Tsp) Mustard | | 90 | g (1 Small) Tomato |
| | 56 | g (2 oz) Lite Cheese | | 28 | g (2 Tbsp) Mayonnaise |
| | 10 | g (2 Tsp) Margarine | | 5 | g (1 Tsp) Mustard |
| | 5 | g (1) Radish | | 13 | g Lettuce Leaves |
| | 36 | g (4) Carrot Sticks | | 253 | g (1 Cup) Split Pea Soup |
| | 50 | g (4) Celery Sticks | | 20 | g (3) Rye Krisp |
| | 166 | g (1) Fresh Pear | | | |
| | 21 | g (7) Vanilla Wafers | | | |
| Snack | 72 | g (30) Grapes | Snack | None | |
| | 58 | g (1) Banana Nut Muffin | | | |
| | 5 | g (1 Tsp) Margarine | | | |
| Dinner | 135 | g (1 Cup) Green Beans | Dinner | 36 | g (½ carrot) Raw Carrot Sticks |
| | 25 | g (1 slice) Wheat Bread | | 50 | g (½ Stalk) Raw Celery Sticks |
| | 15 | g (1 Tbsp) Margarine | | 170 | g (6 oz) Tuna |
| | 138 | g (1) Apple | | 55 | g (4 Tbsp) Mayonnaise |
| | 28 | g (2) Fig Newtons | | 80 | g (½ Cup) Peas |
| | 41 | g (¾ Cup) Lettuce | | 138 | g (1) Raw Apple |
| | 45 | g (½) Tomato Tomato Wedges | | 28 | g (1 slice) Whole Wheat Bread |
| | 15 | g (1 Tbsp) Reg Italian Dressing | | 14 | Walnuts |
| | 113 | g (4 oz) Lean Pork Roast | | 30 | g Pickle Relish |
| | 160 | g (1 Cup) Cooked Noodles | | | |
| Snack | 57 | g (2 oz) American Cheese | Snack | 56 | g (2 oz) Dry Roasted Peanuts |
| | 17 | g (6) Saltine Crackers | | | |

The distribution of total food energy intake for the control diet was about: 24% for breakfast, 27% for lunch, 9% for the 1600-hour snack, 32% for supper, and 8% for the 2100-hour snack. For the Diet₂₀, the distribution was about: 17% for breakfast, 38% for lunch, 32% for supper, and 12% for the 2100-hour snack. The amount of carbohydrate in the meals and snacks for the control diet was approximately 113 g for breakfast, 79 g for lunch, 38 g for the 1600-hour snack, 109 g for dinner and 34 g for the 2100-hour snack (total of 373 g CHO); for the Diet₂₀, it was approximately 25 g for breakfast, 53 g for lunch, 42 g for dinner and 21 g for the 2100-hour snack (total of 141 g CHO).

### Example 3

### Experimental Plan

Subjects were randomized to begin the study with either the test diet or the control diet by a flip of a coin. Six subjects started on the test diet, five subjects started on the control diet. Unfortunately, three of the subjects started on the control diet did not complete the study for personal reasons. Therefore, the data are presented on 8 subjects who completed both arms of the study. Subjects were admitted to the SDTU on the evening prior to the study. The following day, standardized meals containing 55% carbohydrate, 30% fat, and 15% protein (essentially the same as the control diet) were given to all subjects for breakfast, lunch and dinner, at 0800 h, 1200 h, and 1800 h. Subjects were asked to remain in the SDTU during the study period with minimal activity.

On the second day in the SDTU, standardized meals again were given. This diet was similar for both baseline studies and was referred to as “pre-control” and “pre-test” diets depending on which study diet followed the inpatient stay. In addition to the 0800 h, 1200 h and 1800 h meals; snacks were given at 1600 h and 2100 h. Blood was obtained fasting at 0730 h, 0745 h and 0800 h, every 15 minutes for the first hour after meals, every ½-hour for the next two hours, and then hourly until the next meal. Blood was drawn at a total of 46 time points. Following this 24-hour data accumulation period, the subjects were sent home with all the necessary food for the next 2-3 days as appropriate for the diet to which they were randomized.

Subjects returned to the SDTU every 2-3 days to pick up food and meet with the study dietitian. At that time, subjects provided a urine specimen for analysis of creatinine and urea to determine dietary compliance. Subjects were weighed and had blood pressure, total glycohemoglobin, and blood glucose measured. If their body weight decreased or increased on two successive occasions, the total food energy of the meals was increased or decreased as appropriate to attempt to maintain weight stability throughout the study. In addition, subjects were interviewed regarding dietary compliance, and questions or concerns about the study. At the end of the 5-week period, the subjects again were admitted to the SDTU and blood was drawn over a 24-hour period of time as described above. During this time, the test or control meals were continued for each appropriate group. Following this 24-hour data accumulation period, the subjects were sent home to consume a diet of their choice, i.e., their usual diet, for the following ˜5 weeks. This was the washout period.

### Example 4

### Biological Measurements

The plasma glucose concentration and beta-hydroxybutyrate concentration were determined by enzymatic methods using an Analox analyzer with an O₂ electrode (Analox Instruments, Ltd; London, UK). Total glycohemoglobin was measured by boronate affinity HPLC (BioRad Variant, BioRad Labs, Inc.; Hercules, Calif.). Serum immunoreactive insulin was measured using a standard double-antibody radioimmunoassay (RIA) method using kits produced by Incstar (Stillwater, Minn.). Glucagon and C-peptide were measured by RIA using kits from Linco Research (St. Louis, Mo.) and Diasorin (Stillwater, Minn.), respectively. NEFAs were measured enzymically using a kit manufactured by Wako Chemicals, Inc. (Richmond, Va.). Weight was determined in street clothes without shoes on a digital scale (Scalitronix, White Plains, N.Y.). Blood pressure was measured using a Dinemap instrument (Critikon/Mediq, Pennsauken, N.J.).

The total alpha amino nitrogen concentration was determined by the method of Goodwin, which is a measure of the total amino acid concentration. The plasma TSH (Abbott Architect; Abbott Park, Ill.), GH (Quest; New Brighton, Minn.), B12 and folate (Diagnostic Products Corp.; Los Angeles, Calif.) were determined by chemiluminescence. Total T3 and free T4 were determined by Chemiflex (Abbott Architect). IGF-1 was determined by RIA (Quest). Homocysteine was measured by HPLC (Hewlett Packard, Palo Alto, Calif.). The plasma and urine creatinine, urea nitrogen and uric acid were measured by an automated method on an OrthoClinical diagnostic Vitros 950 analyzer (Raritan, N.J.). Microalbumin was determined using a Beckman-Coulter array 360 analyzer (Fullerton, Calif.). Urinary free cortisol was determined in the laboratory of Dr. B. Pearson-Murphy using an HPLC purification step followed by a cortisol binding assay. Urinary aldosterone was determined by RIA (Diagnostic Products Corp.). Urinary calcium and magnesium were measured colorimetrically on a J&J Vitros Instrument (J&J Engineering; Poulsbo, Wash.). Qualitative urinary ketones were measured with a Ketostix (Bayer Corporation; Elkhart, Ind.).

The total amount of protein oxidized was determined by quantifying the urine urea nitrogen excreted over the 24 hours of the study in association with the change in the amount of urea nitrogen retained endogenously. The latter was calculated by determining the change in plasma urea nitrogen concentration between the fasting baseline and at the end of the 24-hour study period, and correcting for plasma water by dividing by 0.94. In this calculation, it is assumed that there is a relatively rapid and complete equilibration of urea in total body water. Total body water as a percentage of body weight was calculated as previously described (Watson et al., 1980, Am. J. Clin. Nutr., 33:27-39). The overall assumption is that a change in plasma urea concentration is indicative of a corresponding change in total body water urea concentration. In this 24-hour study, the beginning and ending urea nitrogen concentrations were essentially identical, indicating no retention of urea. The sum of total urea nitrogen in urine and body water was divided by 0.86 to account for 14% lost to metabolism in the gut.

The net 24-hour incremental area responses were calculated using the overnight fasting value as baseline. Total 24-hour area responses were calculated using zero as the baseline. Both area calculations were done using a computer program based on the trapezoid rule. Statistics were determined using Student's t test for paired variates, with the Statview 512+ program (Brain Power, Calabasas, Calif.) for the Macintosh computer (Apple Computer, Cupertino, Calif.). A p value of <0.05 was the criterion for significance. Data are presented as the mean±SEM, unless otherwise indicated.

### Example 5

### Results #1

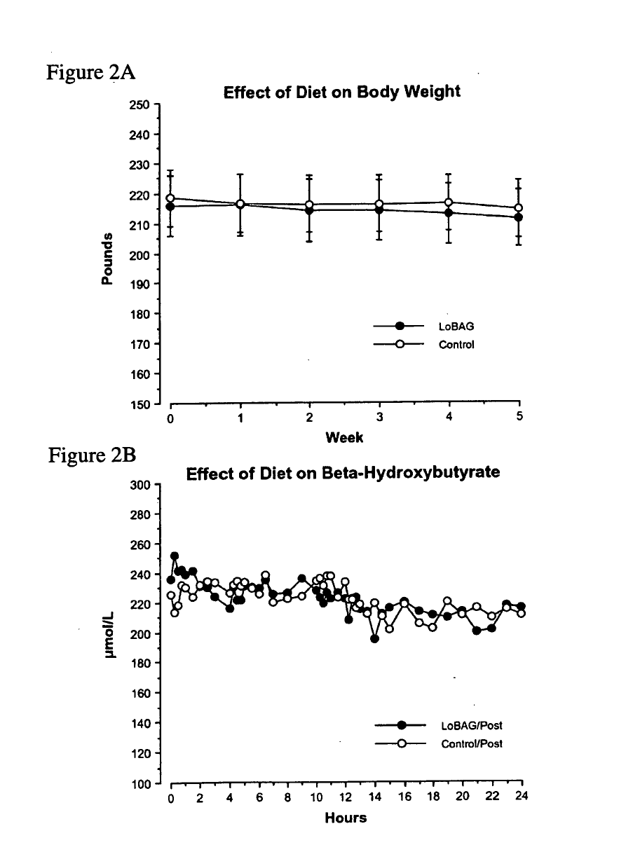

The average body weight was 219±10 lbs (99±4.5 kg) and 216±10 lbs (98±4.5 kg) at the beginning of the control and test diets, respectively. At the end of the 5 weeks on the control diet, the average body weight was 215±10 lbs (98±4.5 kg). Following 5 weeks on the test diet, the average weight was 212±9 lbs (96±4.1 kg). Thus, the average body weight decreased by 4 pounds (1.8 kg) during the 5-week study period, regardless of diet (FIG. 2A).

Urine ketones were monitored twice weekly while subjects were on the test diet. They were always zero to trace using nitroprusside impregnated Ketostix (Bayer Corporation, Elkhart, Ind.). Twenty-four hour urine ketones were identical at the beginning and end of the test diet (196±8 μmol/L and 196±9 μmol/L respectively). Before and after the control diet, they were 187±7 μmol/L and 203±10 μmol/L, respectively.

The mean fasting B-hydroxybutyrate concentration was 225±15 μmol/L after five weeks on the control diet (FIG. 2B). Following five weeks on the test diet, the mean fasting concentration was 236±27 μmol/L. The 24-hour profiles were similar when the subjects ingested either the control or the test diet.

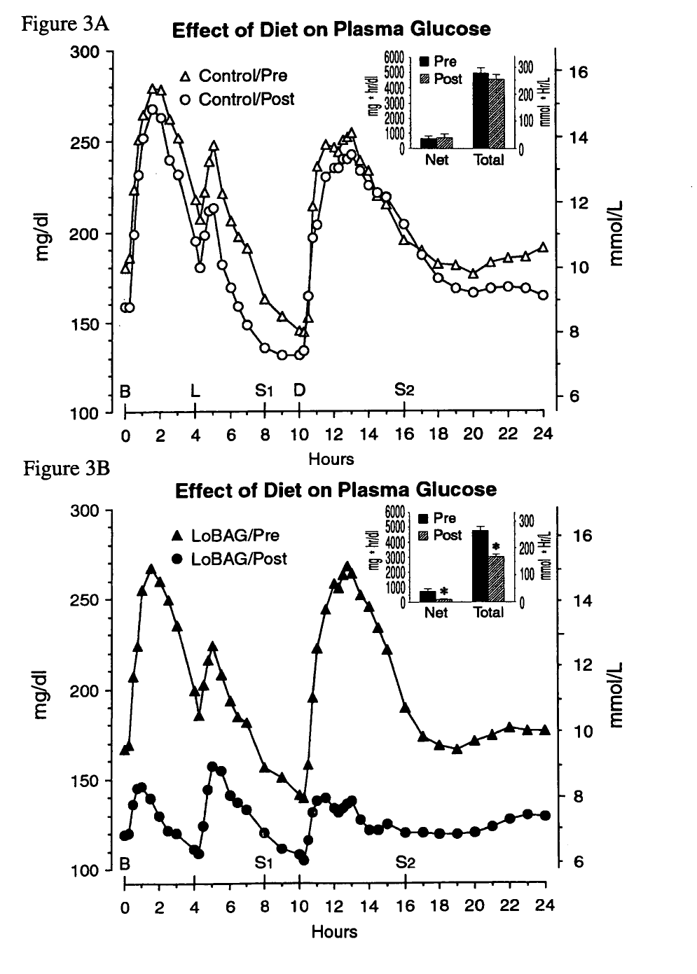

The mean fasting glucose concentration prior to starting the control diet was 180±10 mg/dl (10±0.6 mmol/L) (FIG. 3A). After five weeks on the control diet, the fasting glucose concentration was decreased to 159±11 mg/dl (8.8±0.6 mmol/L), but this was not significant (p=0.66). Prior to starting the test diet the mean fasting glucose concentration was 167±13 mg/dl (9.3±0.7 mmol/L), similar to that prior to starting the control diet (p=0.24). After 5 weeks on the test diet, the fasting glucose concentration was significantly decreased to 119±7 mg/dl (66±0.4 mmol/L) (p<0.003) (FIG. 3B).

The mean 24-hour integrated net glucose area responses were similar for the pre-control, pre-test and post-control diets (681±174, 731±159 and 730±236 mg·h/dl [38±9.7, 41±8.8, 41±13.1 mmol·hr/L], respectively) (FIG. 3, insets, left bars). Following five weeks on the test diet, the net mean 24-hour integrated glucose area response was decreased by 77% (165±59 mg·h/dl) (9.2±3.3 mmol·hr/L) (p<0.02).

Total 24-hour integrated glucose area responses also were similar for pre-control, pre-test and post-control diets (4998±337, 4746±301 and 4554±347 mg·h/dl [278±18.7, 264±16.7, 253±19.3 mmol·hr/L], respectively) (FIG. 3, insets, right bars). The total area response following 5 weeks on the test diet was decreased significantly (3023±160 mg·h/dl) (168±8.9 mmol·hr/L) (p<0.0004 compared to the 5-week post-control and p<0.0001 compared to pre-test). Based on these integrated areas, the mean glucose concentration over the 24 hour periods of study was reduced from 198 mg/dl to 126 mg/dl (11 mmol/L to 7 mmol/L) after 5 weeks on the test diet, a 36% decrease (p<0.0001).

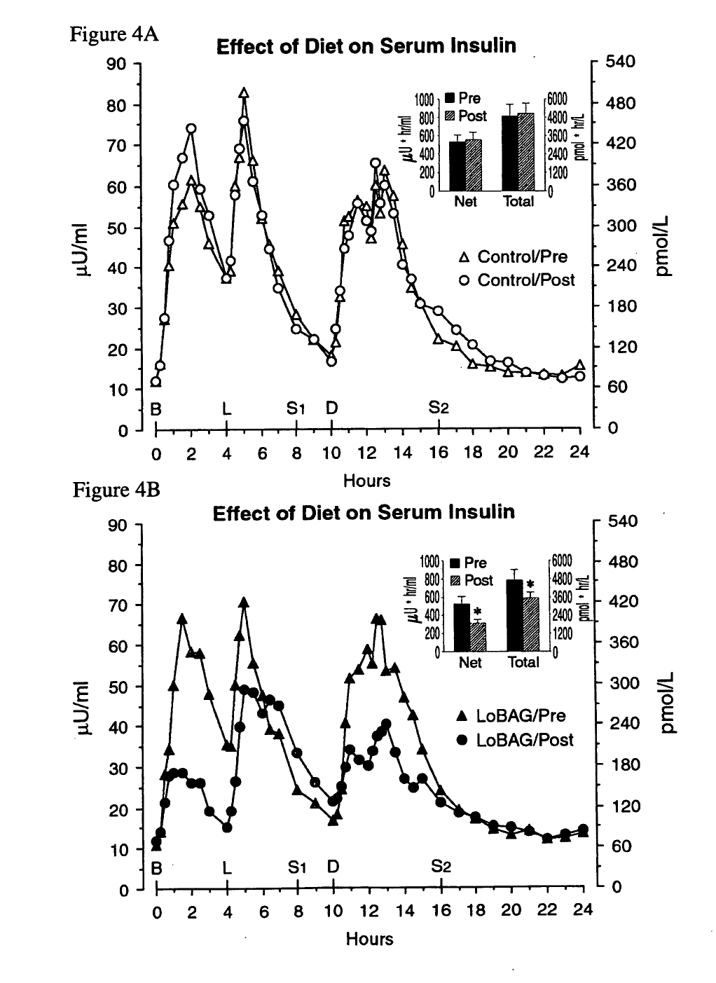

The mean fasting insulin concentrations before and after 5 weeks on both the control and test diets were identical (12±2 μU/ml) (72±12 pmol/L) (FIGS. 4A and 4B).

The mean 24-hour integrated insulin area response above the fasting value was similar following the pre- and post-control diet and pre-test diet (534±73 μU·h/ml; 554±84 μl·h/ml; and 530±81 μl·h/ml [3024±438, 3324±504, 3180±486 μmol/L], respectively) (FIG. 4, insets). It was decreased at five weeks on the test diet (318±39 μU·h/ml) (1908±702 μmol/L). This was a decrease of 40% from the pre-test value (p<0.01) (FIG. 4, insets). The mean 24-hour total integrated insulin area response decreased by 25%.

The mean fasting C-peptide concentration before and after the control diet was 0.86±0.08 and 0.91±0.08 pg/ml, and 0.81±0.09 and 0.92±0.08 before and after the test diet. The 24-hour time course response was similar to the insulin response. The net C-peptide area response was decreased by 34% after 5 weeks on the test diet. This was statistically significant (p<0.05).

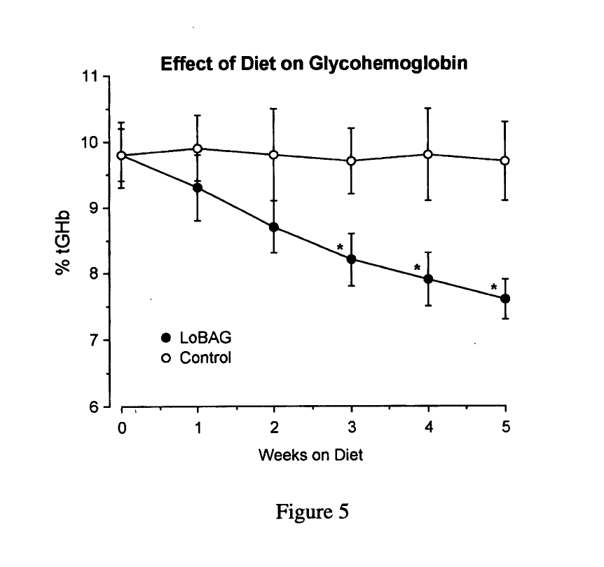

The mean total glycohemoglobin was essentially unchanged during the 5 weeks on the control diet (FIG. 5). A decrease in total glycohemoglobin was present 1 week after the institution of the test diet, and became significant after 3 weeks on the test diet. At the end of the 5-week period, the total glycohemoglobin had decreased 22%, from 9.8±0.5% to 7.6±0.3% (p<0.0007).

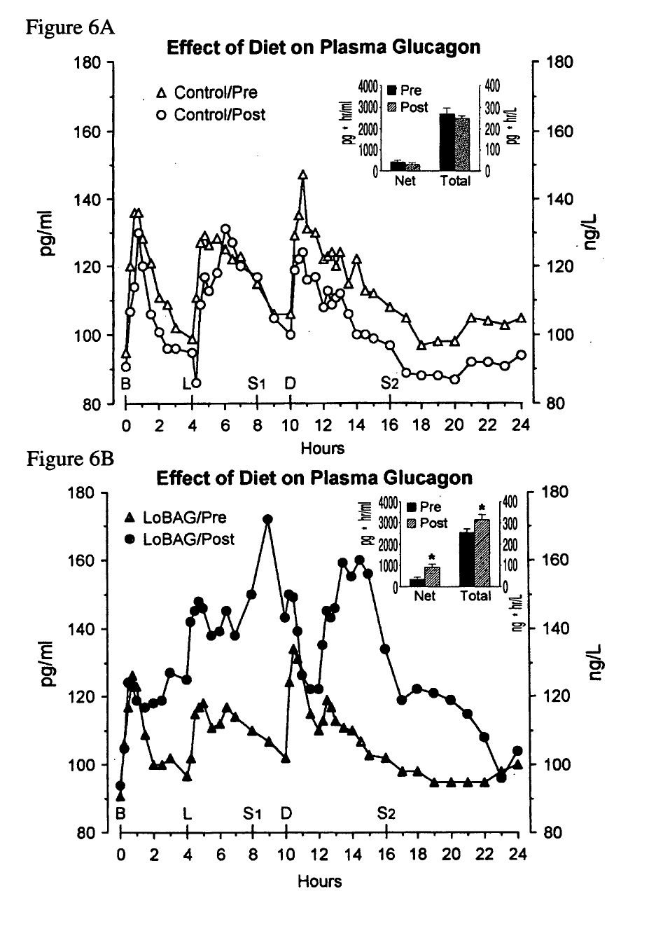

The mean fasting glucagon concentrations were similar before and after both the control and test diets (95±11, 91±8, 91±7, and 94±7 pg/ml, respectively) (FIGS. 6A and 6B). After 5 weeks on the test diet, the glucagon response was similar to the control for the first hour after breakfast. Subsequently, the glucagon concentration was higher at every time point until 0700 hr the following morning, except for one time point after dinner. Both the net and the total glucagon area responses were significantly increased after the test diet (p≦0.05) (FIG. 6, insets).

The mean fasting NEFA concentrations were 765±67, 654±59, 718±70 and 593±50 μEq/1, before and after the control and test diets, respectively. These differences were not statistically significant (p>0.05). The 24-hour excursions were similar on the pre-control and pre-test diet days. When the test diet was ingested, the fasting NEFA was lower, the increase after the lunch meal was attenuated, as was the decrease before dinner. The rise after dinner was more rapid and reached a higher concentration.

The mean 24-hr integrated net NEFA area responses were (−)5323±1187, (−)2468±693, (−)4525±1660 and 80±1809 μEq hr/1 before and after the control and test diets, respectively. The small positive area response after the test diet was statistically significantly different compared to the response before the test diet (p<0.05). Total areas were not statistically different from one another.

The mean fasting triacylglycerol concentrations were 264±36, 226±32, 246±27 and 149±23 mg/dl before the after the control and test diets, respectively. The fasting triacylglycerol concentration was significantly lower after 5 weeks on the test diet (p<0.05). After ingestion of either diet, the triacylglycerol concentration increased until ˜1200-1400 h, decreased at 2000-2200 h, increased slightly at ˜2400 h and subsequently returned to the fasting value by 0800 h the following morning.

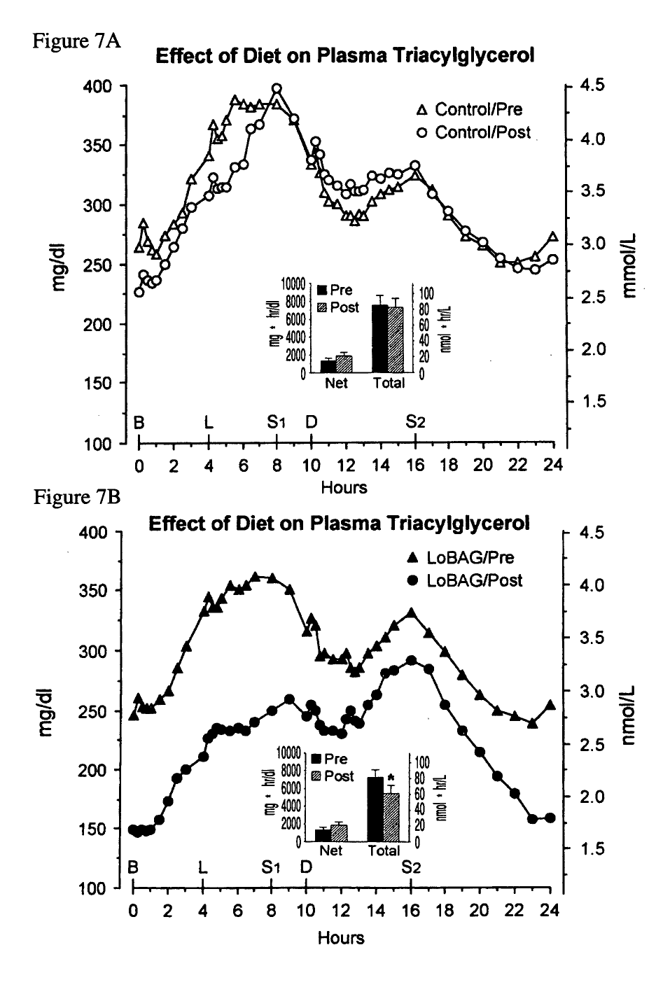

The mean 24-h integrated net triacylglycerol area response was not significantly different between diets. However, the mean 24-h integrated total area response was significantly lower after 5 weeks on the test diet (p<0.05) (FIG. 7, insets).

The total cholesterol concentrations were 195±7, 184±17, 188±10 and 177±8 mg/dl before and after the control and test diets, respectively. The LDL-cholesterol concentrations were 105±9, 102±2, 105±7, and 110±6 mg/dl before and after the control and test diets, respectively. The HDL-cholesterol concentrations were 38±1, 37±2, 37±2, and 36±2 before and after the control and test diets, respectively. The total, LDL, and HDL concentrations were not significantly different between diets or before and after each diet.

The serum total, LDL, and HDL cholesterol concentrations did not change significantly when the fat content of the diet was increased from 30% to 50% of total food energy. This was most likely due to the saturated fatty acid content being kept at 10% of energy in both diets. The test diet dramatically reduced 24-hour integrated glucose concentration and consequently the percent glycohemoglobin in people with type 2 diabetes. These positive results occur without a significant change in serum lipids, except for a significant decrease in triacylglycerol concentration.

### Example 6

### Results #2

The plasma alpha amino nitrogen (AAN) concentration increased after meals, as expected. When the meals contained 15% protein (control diet), the AAN concentration increased with each meal but decreased to near basal levels between meals. However, when the diet contained 30% protein (Diet₂₀), only modest decreases were measured after breakfast and lunch. The AAN concentration did return to the fasting concentration overnight in all cases. The increase in AAN after the dinner meal in the control/pre is unexplained.

The net area response integrated over 24 hours using the fasting value as baseline were 2.6, 3.6, 4.8 and 15 mg·hr/dl in the control/pre, control/post, Diet₂₀/pre and Diet₂₀/post diets, respectively. Thus, the area response was ˜3 fold greater after ingestion of the Diet₂₀, which contained twice as much protein (p<0.05). When the total area was calculated using zero as a baseline, the response to the Diet₂₀ again was significantly greater (p<0.05).

The fasting plasma urea nitrogen was 14-15 mg/dl before and after the control diet and before instituting the Diet₂₀. At the end of the 5-week period on the Diet₂₀, it had increased to 22 mg/dl. Thus, the Diet₂₀ at 30% protein resulted in a 57% increase in fasting plasma urea nitrogen. A gradual further small increase in urea nitrogen occurred throughout the day while ingesting the Diet₂₀, until the 17-hour time point, after which the concentration decreased to 21 mg/dl by the following morning. This late evening increase in concentration was nearly identical to that reported previously in subjects who ingested a 30% protein, 40% carbohydrate, 30% fat diet (Diet₄₀). The total urea nitrogen area response, using zero as baseline, was 45% greater (p<0.05) after ingestion of the Diet₂₀.

The calculated total amount of protein ingested during the 24-hour study period was compared with the total protein metabolized. After ingestion of the 15% protein meals (control), 106 g of protein were calculated to have been ingested and 92 g were calculated to have been metabolized (87%). After ingestion of the 30% protein meals (Diet₂₀), 212 g of protein were calculated to have been ingested and 142 g were calculated to have been metabolized (67%). This difference was statistically significant (p<0.03).

Serum growth hormone concentrations did not differ significantly between treatments. The serum IGF-1 concentration was similar before and after ingestion of the control diet and before ingestion of the Diet₂₀. However, it increased significantly from a mean of 115 to 161 ng/ml after 5 weeks on the Diet₂₀ (p<0.01).

Plasma renin activity was determined in 7 subjects. There was a mean increase when the subjects ingested the control diet. After institution of the Diet₂₀, plasma rennin activity decreased (Table 4). These differences were not statistically significantly different (p=0.13 and 0.20, respectively).

Mean 24-hour urinary aldosterone excretion was not different between diets. The mean urinary free cortisol was obtained in only 6 subjects. Mean urinary free cortisol increased by 44% consequent to the ingestion of the Diet₂₀, but this was not statistically significant (p=0.17).

Neither the serum TSH, free T4, nor the Total T3 were significantly affected by ingestion of the Diet₂₀, even though the Diet₂₀ contained much less carbohydrate than the control diet (Table 4).

Blood pressure remained unchanged. Serum homocysteine, folate and B12 also remained unchanged (Table 4). Urinary β-hydroxybutyrate excretion did not increase, nor did the urinary pH change when the subjects ingested the Diet₂₀ (Table 5). The creatinine clearance and microalbumin excretion also did not change. Sodium excretion was increased. The 24-hour urinary urea nitrogen increased when the subjects ingested the Diet₂₀. However, the mean increase was only ˜60%, and not 2-fold as might be expected with a doubling of the protein content in the diet.

TABLE 4
Blood pressure, plasma/serum hormones, vitamins & metabolites

| | Control-Pre | Control-Post | Diet₂₀-Pre | Diet₂₀-Post |
|---|---|---|---|---|
| Blood | 133/77 | 127/72 | 146/76 | 133/74 |
| Pressure | | | | |
| (mmHg) | | | | |
| Serum | 0.9 ± 0.1 | 0.9 ± 0.05 | 0.9 ± 0.05 | 1.0 ± 0.05* |
| Creatinine | | | | |
| (mg/dl) | | | | |
| Renin | 0.64 ± 0.3 | 1.03 ± 0.3 | 0.69 ± 0.1 | 0.47 ± 0.1 |
| (ng/ml) | | | | |
| Serum Uric | 4.9 ± 0.2 | 5.5 ± 0.03 | 5.3 ± 0.3 | 5.8 ± 0.3 |
| Acid (mg/dl) | | | | |
| TSH | 1.60 ± 0.22 | 1.49 ± 0.16 | 1.50 ± 0.13 | 1.39 ± 0.16 |
| (μIU/ml) | | | | |
| Total T₃ | 83.3 ± 8.5 | 79.6 ± 7.3 | 86.9 ± 7.9 | 81.9 ± 6.9 |
| (ng/dl) | | | | |
| Free T₄ | 0.90 ± 0.04 | 0.85 ± 0.02 | 0.98 ± 0.05 | 1.04 ± 0.03 |
| (ng/dl) | | | | |
| Folate | 16.5 ± 2.3 | 20.2 ± 1.3 | 18.0 ± 2.1 | 15.8 ± 2.2 |
| (ng/ml) | | | | |
| Homo- | 8.1 ± 0.7 | 8.1 ± 0.8 | 8.9 ± 1.1 | 7.8 ± 2.1 |
| cysteine | | | | |
| (μg/dl) | | | | |
| B₁₂ (pg/ml) | 524 ± 119 | 496 ± 99 | 557 ± 120 | 475 ± 108 |

Values are Mean ± SEM
*p < 0.02 compared to Diet₂₀-Pre

TABLE 5
Urine data

| | Control-Pre | Control-Post | Diet₂₀-Pre | Diet₂₀-Post |
|---|---|---|---|---|
| Volume (ml) | 4129 ± 707 | 3961 ± 691 | 4366 ± 502 | 4127 ± 558 |
| Glucose (g) | 22 ± 8 | 14 ± 4 | 17 ± 9 | 0.3 ± 0.3 |
| Potassium | 3315 ± 254 | 3471 ± 312 | 3471 ± 250 | 3081 ± 156 |
| (mg) | | | | |
| Sodium (mg) | 5451 ± 276 | 5451 ± 713 | 4692 ± 253 | 6923 ± 759* |
| Urea (g) | 12.2 ± 0.9 | 13.3 ± 1.0 | 12.8 ± 0.9 | 20.6 ± 1.4* |
| Uric Acid | 0.84 ± 0.12 | 0.72 ± 0.06 | 0.78 ± 0.11 | 0.90 ± 0.09† |
| (g) | | | | |
| Micro | N/A | 9.7 ± 1.7 | N/A | 8.3 ± 1.1 |
| albumin | | | | |
| (mg) | | | | |
| β-OH | 187 ± 7 | 203 ± 10 | 196 ± 8 | 196 ± 8 |
| butyrate | | | | |
| (μM) | | | | |
| Calcium (g) | 220 ± 52 | 217 ± 62 | 221 ± 62 | 214 ± 64 |
| pH | 6.3 ± 0.1 | 6.2 ± 0.1 | 6.1 ± 0.1 | 6.2 ± 0.1 |
| Creatinine | 1.8 ± 0.15 | 1.7 ± 0.13 | 1.8 ± 0.13 | 1.8 ± 0.15 |
| (g) | | | | |
| Creatinine | 143 ± 15 | 127 ± 13 | 117 ± 51 | 137 ± 10 |
| clearance | | | | |
| (ml/min) | | | | |

Values are mean ± SEM
*p < 0.05 compared to Diet₂₀-Pre
†p = 0.06 compared to Diet₂₀-Pre

### B. Diet30

### Example 1

### Participants

Eight men with mild, untreated type 2 diabetes were studied in a special diagnostic and treatment unit (SDTU), similar to a clinical research center. All participants met the National Diabetes Data Group criteria for the diagnosis of type 2 diabetes and were not being treated with oral hypoglycemic agents or insulin. Participant characteristics are given in Table 6. The Department of Veterans Affairs Medical Center and the University of Minnesota Committees on Human Subjects approved the study, and all participants gave written informed consent prior to enrollment in the study. Exclusion criteria included: hematological abnormalities, kidney disease, liver disease, macroalbuminuria (>300 mg/24 h), congestive heart failure, or untreated thyroid disease. Before the study, participants were interviewed to determine their physical activity profile, any food aversions and to explain the study process and commitment in detail. Participants confirmed that they had been weight stable for at least 3 months. They were instructed to maintain their current activity level throughout the study. Two weeks before beginning the study, the participants completed a 3-day food questionnaire, with one of the days being a Saturday or a Sunday. This information was used to calculate the total food energy necessary to maintain body weight.

TABLE 6
Patient characteristics

| | | | | | | Duration | | |
|---|---|---|---|---|---|---|---|---|
| | Age | Height | Weight | BMI | tGHb | of diabetes | | |
| Patient | (yrs) | (cm) | (kg) | (kg/m²) | (%) | (months) | Concomitant diseases | Medications |
| 1 | 50 | 175 | 97 | 32 | 10.0 | 42 | hypertension, | bupropion, clonazepam, |
| | | | | | | | hypercholesterolemia, | cyclobenzapine |
| | | | | | | | multiple sclerosis, major | gabapentin, glatiramer |
| | | | | | | | depressive disorder, | acetate, nifedipine, |
| | | | | | | | trigeminal neuralgia | sertraline |
| 2 | 64 | 178 | 75 | 24 | 11.2 | 48 | hypertension, | none |
| | | | | | | | traumatic brain injury | |
| 3 | 52 | 173 | 85 | 29 | 8.7 | 24 | none | aspirin |
| 4 | 67 | 183 | 92 | 28 | 11.0 | 180 | hypertension | none |
| 5 | 57 | 185 | 120 | 35 | 11.2 | 36 | dyslipidemia | none |
| 6 | 56 | 180 | 89 | 27 | 11.4 | 72 | seizure disorder, post- | aspirin, phenytoin |
| | | | | | | | traumatic stress disorder | |
| 7 | 64 | 185 | 110 | 32 | 9.9 | 132 | hypertension, | Atorvastatin, |
| | | | | | | | hypercholesterolemia | lisinopril |
| 8 | 62 | 175 | 82 | 27 | 12.7 | 66 | dyslipidemia, GERD | Simvastatin, |
| | | | | | | | | ranitidine |
| Mean | 59 | 179 | 94 | 29 | 10.8 | 75 | — | — |
| Range | 50-67 | 173-185 | 75-120 | 24-35 | 8.7-12.7 | 24-180 | — | — |

### Example 2

### Diet

The study diet was designed to consist of 30% carbohydrate, 30% protein, and 40% fat. The saturated fatty acid content of the diet was approximately 10% of total food energy; thus, the majority of the fat was mono- and polyunsaturated. This diet is referred to as Diet₃₀. The diet composition of the Diet₃₀ is given in Table 7 and representative meals are shown in Table 8. Each patient was on the six-day rotation for a total of five weeks.

TABLE 7
Composition of Diet₃₀

| | | |
|---|---|---|
| Protein (g) | 228 | 33% |
| Carbohydrates (g) | 202 | 29% |
| Fat (g) | 124 | 40% |
| Cholesterol (mg) | 640 | |
| Dietary fiber (g) | 23 | |
| Saturated fat | 11% | |
| Monounsaturated fat | 17% | |
| Polyunsaturated fat | 9% | |
| Calories | 2810 | |

TABLE 8
Sample Menu of Diet₃₀

```
Breakfast
    Omelet:
      170. g (6 ounces) egg substitute
      56.8 g (2 ounces) low fat cheddar cheese
      1 green onion
      ¼ green pepper
      1 Slice Whole Wheat Toast
      1 Tbsp Peanut Butter
      1 Cup 2% Milk
      1 Orange
Lunch
    Chef's salad:
      1 hard cooked egg
      1½ Cups Lettuce
      28.4 g (1 ounce) extra lean ham
      56.8 g (2 ounces) white turkey
      ½ cup celery
      56.8 g (2 ounces) low fat cheese
      2 Tbsp Vinegar and Oil
      ¼ cup water chestnuts
      4 Rye Krisp wafers
      1 tsp Fleishman's soft margarine
      1 apple
Supper
      227.2 g (8 unces) roast beef
      56.8 g (2 ounces) diet coleslaw
      ½ Baked Potato
      ½ Cup Peas
      1 Tsp Margarine
      1 Cup 2% Milk
      1 Par
Snack
      ½ Sandwich: 1 slice Whole Wheat Bread,
      8.4 g (1 ounce) Swiss Cheese, 56.8 g (2 ounces) turkey),
      1 lettuce leaf) 1 Tsp Margarine, 28.4 g (1 ounce) peanuts
```

### Example 3

### Experimental Plan

Participants were admitted to the SDTU on the evening prior to the study. The next day, standardized meals containing 55% carbohydrate, 30% fat, and 15% protein (control diet) were given for breakfast, lunch and dinner at 0800, 1200, and 1800. Participants were asked to remain in the SDTU during the study period with minimal activity.

On the second day in the SDTU, standardized meals again were given. In addition to the meals at 0800, 1200 and 1800, snacks were given at 1600 and 2100. Fasting blood was obtained at 0730, 0745, and 0800. Then samples were collected every 15 min for the first hour after meals, every 30 min for the next 2 h, and then hourly until the next meal. Blood was drawn at a total of 46 time points. After this 24-h data accumulation period, the participants were sent home with all of the necessary food for the next 2-3 days according to the Diet₃₀ menu plan.

Participants returned to the SDTU every 2-3 days to pick up food and meet with the study dietitian and study coordinator. At that time, the subjects provided a urine specimen for analysis of creatinine and urea to determine dietary compliance. They also were weighed and had blood pressure, total glycohemoglobin (tGHb), and blood glucose measured. If their body weight decreased or increased on two successive occasions, the total food energy of the meals was increased or decreased as appropriate to attempt to maintain stable weight throughout the study. In addition, participants were interviewed regarding dietary compliance during each visit. At the end of the 5-week period, the participants again were admitted to the SDTU and blood was drawn as described above. At this time, participants were given the meals (breakfast, lunch, dinner, and snacks) as appropriate for the day in the Diet₃₀ menu rotation.

### Example 4

### Biological Measurements

The plasma glucose concentration, HDL cholesterol, and total cholesterol were measured with the use of an automated method on an Ortho-Clinical Diagnostics Vitros 950 analyzer (Raritan, N.J.). LDL cholesterol was calculated with the Fridedwald Formulation. The β-hydroxybutyrate concentration was determined by colormetric assay (STANBIO, Boerne, Tex.). % tGHb was measured by boronate-affinity high-performance liquid chromatography (BioRad Variant; BioRad Labs, Hercules, Calif.). Serum immunoreactive insulin was measured using standard double-antibody radioimmunoassay kits from Incstar (Stillwater, Minn.). Glucagon and C-peptide were measured with radioimmunoassay kits from Linco Research (St. Louis, Mo.) and Diasorin (Stillwater, Minn.), respectively. Weight was determined in street clothes without shoes on a digital scale (Scalitronix, White Plains, N.Y.). Blood pressure was measured using a Dinemap instrument (Critikon/Mediq, Pennsauken, N.J.).

The plasma creatinine, plasma urea nitrogen, uric acid were measured with the use of an automated method on an Ortho-Clinical Diagnostics Vitros 950 analyzer (Raritan, N.J.). NEFAs were measured enzymatically using a kit manufactured by Wako Chemicals (Richmond, Va.).

The net 24-h incremental area responses were calculated using the overnight fasting value as baseline. Total 24-h area responses were calculated using zero as the baseline. Both area calculations were done using a computer program based on the trapezoid rule. Statistics were determined using Student's t test for paired variates, with the Statview 512+ program (Brain Power, Calabasas, Calif.) for the Macintosh computer (Apple Computer, Cupertino, Calif.). P<0.05 is the criterion for significance. Data are presented as the mean±SE. Prospective power calculation, with β equal to 90%, resulted in n=3.

### Example 5

### Results #1

The average body weight was 206±11.3 lb (94±5.1 kg) before the diet. At the end of the 5 weeks on the diet, the average weight was essentially unchanged 204±11.2 lb (93±5.1 kg).

Urine ketones were monitored twice weekly while participants were on the Diet₃₀. The majority of the samples were zero to trace using nitroprusside impregnated tablets (Bayer, Elkhart, Ind.); two single samples were positive for ketones.

The total area of the 24-h plasma β-hydroxybutyrate data was modestly higher after the Diet₃₀ but not significantly.

The mean fasting plasma glucose concentration decreased significantly from 227±18.6 mg/dl (12.6±1 mmol/L) to 130±14.3 mg/dl (7.2±0.79 mmol/L; P=0.001) after 5 weeks on the diet). The mean 24-h integrated net glucose area response decreased from 1269±269 mg·hr/dl (70.5±14.9 μmol·hr/L) to 449±129 mg·hr/dl (24.9±7.2 μmol·hr/L) (P=0.001). The total area response decreased from 6717±501 mg·hr/dl (373±27.8 μmol·hr/L) to 3724±348 mg·hr/dl (207±19.3 μmol·hr/L; P=0.0001).

The mean fasting serum insulin concentration was unchanged (8.4±1.1 μU/ml (50.4±6.6 pmol/L) and 9.0±1.0 μU/ml (54±6 μmol/L)) before and after 5 weeks on the diet, respectively. The mean 24-h integrated net insulin area response and the total integrated insulin area response also remained essentially unchanged after 5 weeks on the diet.

The mean fasting serum C-peptide concentration also was unchanged after 5 weeks on the diet (0.6±0.1 ng/ml to 0.8±0.2 ng/ml, P=0.3). The 24-h time course response was similar to the insulin response. The net C-peptide area response decreased from 11.4±2.4 ng·hr/ml to 10.6±1.4 ng·hr/ml after 5 weeks on the Diet₃₀. This was not statistically significant (P>0.05). The 24-h total area did not change before or after the diet, 25±2.9 ng·hr/ml to 25.8±2.54 ng·hr/ml respectively.

The mean % tGHB decreased from 10.8±0.4% to 9.1±0.5%, before and after the diet respectively (P<0.0001). In addition, at the end of the study, it was still decreasing in an essentially linear fashion.

The mean fasting plasma glucagon concentrations were similar before and after the diet; 76±3.1 pg/ml and 77±11.1 pg/ml, respectively. Both the 24-h integrated net response and the 24-h total area response increased after 5 weeks on the diet. These were not statistically significant (P=0.33 and P=0.32, respectively).

The mean fasting plasma triacylglycerol concentration significantly decreased from 190±24.5 mg/dl to 113±9.4 mg/dl after 5 weeks on the diet (P=0.007); however the decrease seen with the 24-h net area was not statistically significantly. The 24-h total area response significantly decreased from 5695±806 mg·hr/ml to 3586±326 mg·hr/ml (P=0.008). The total cholesterol concentration significantly decreased from 189 mg/dl to 152 mg/dl after 5 weeks on the diet (P=0.004). The plasma LDL and HDL concentration decreased from 113 to 95 and from 37 to 34, respectively, which was not significant.

### Example 6

### Results #2

The mean fasting NEFA concentrations decreased from 691±74.6 μEq/L to 622±54.8 μEq/L. This was not statistically significant (P>0.05). The mean 24-h integrated net NEFA area response was increased after 5 weeks on the Diet₃₀, however this was not significant (P>0.05). Differences in the 24-h total areas were also not statistically significant.

The mean fasting alpha amino acid nitrogen concentration was 4.01±0.1 mg/dl before the diet and remained unchanged after 5 weeks on the diet. The 24-h integrated net and 24-h total area responses were significantly increased after 5-weeks on the Diet₃₀.

The mean fasting plasma creatinine level remained unchanged, 0.9 mg/dl and 0.9 mg/dl, before and after the diet respectively. However, the mean 24-h integrated net creatinine response increased from 0.3±0.3 mg·hr/dl to 1.7±0.5 mg·hr/dl (P=0.768). This difference was also present when correcting for the baseline with the 24-h total area response.

The mean fasting uric acid concentration increased from 4.7±0.4 mg/dl to 5.5±0.4 mg/dl (P=0.002) and remained elevated throughout the 24-h study period. The 24-h net area decreased modestly after 5 weeks on the diet (P=0.9). However, the 24-h integrated total area significantly increased from 106±9.6 mg·hr/dl to 124±8.2 mg·hr/dl (P=0.0013).

The mean fasting plasma urea nitrogen concentration increased from 15±1 mg/dl to 19±1.8 mg/dl after 5 weeks on the diet (P<0.05). The 24-h net area response increased from −4±7.1 mg·hr/ml to 28±11.7 mg·hr/ml; however this was not significant (P=0.09). The 24-h integrated total area increased from 346±22 mg/dl to 479±42 mg/dl (P=0.0038).

To determine whether subjects with type 2 diabetes experience a decrease in fasting or random glucose concentration, a decrease in postprandial glucose concentration and decrease in glycated hemoglobin as great or greater than observed after 5 weeks of ingesting a LoBAG diet, while remaining weight stable, additional, longer-term studies were done.

### Ten Week Study (Highly Controlled Setting)

### Study Subjects

Potential volunteers were screened and found to be free of other major medical conditions such as hematologic abnormalities, liver disease, kidney disease, untreated thyroid disease, congestive heart failure, angina, life-threatening malignancies, proliferative retinopathy, diabetic neuropathy, peripheral vascular disease, serious psychological disorders, and had a body weight<136 kg (300 lb). The inclusion criteria for the study were subjects with type 2 diabetes, C-peptide positive (indicating they could still secrete insulin), whose fasting glucose concentration was less than 200 mg/dl, who were not taking oral hypoglycemic agents at the time of the study and had never taken insulin. All subjects had been taking one oral hypoglycemic medication before enrolling in the study. These medications were discontinued for varying periods of time to allow the glycated hemoglobin to stabilize before the study was begun. Diabetes medications were discontinued, with the approval of the primary care provider, because the objective of the study was to determine the effect of the LoBAG diet per se, without the confounding effect of a hypoglycemic agent. Allowing the glycated hemoglobin to stabilize before starting the study assured that the maximum effect of the diet would be observed, i.e., the decrease due to the diet was not masked by the increase due to discontinuation of the medication. Other medications being taken by the subjects were continued and remained unchanged during the entire study. The study was approved by the Department of Veterans Affairs Medical Center and the University of Minnesota Committees on Human Subjects. Table 8 (below) shows the details of the patient characteristics.

### Diet

A six-day rotating menu was used which was calculated to consist of 30% carbohydrate, 30% protein, 40% fat (10% saturated fat) (LoBAG₃₀) (Reference 10). The diet contains foods typical of those consumed by our patient population. Dietary preferences were accommodated whenever possible. All food was provided to the subjects. The total food energy of the diet was individualized to insure that each subject remained weight stable during the study. Our protocol differs from others in the literature using a high protein-low carbohydrate diet (Reference 12), in that our subjects are weight stable during the study. This was done to eliminate the potential confounding effect of weight loss on blood glucose control.

### Protocol

Eight subjects with type 2 diabetes, who were not taking any diabetes medications, or were willing, with their primary care-provider's permission, to stop the medications during the study, were enrolled in, and completed the 10-week study.

### Baseline

Before beginning the study, the subjects reported to our Special Diagnostic & Treatment Unit (similar to a clinical research center) for a period of ˜40 hours. On the day of admission, they received a standard diet consisting of 55% carbohydrate, 15% protein and 30% fat for dinner at ˜1800 hr and a snack at 2100 hr, and then were allowed only water until 0800 the following morning. Blood was drawn at 47 time points during the subsequent 24 hours for glucose, insulin, C-peptide, glucagon, triacylglycerol, alpha amino acid nitrogen (AAN), non-esterified fatty acids (NEFA), uric acid, urea nitrogen, and creatinine. Urine also was collected for determination of microalbumin, calcium, creatinine, glucose, pH, potassium, sodium, urea and uric acid. During this 24-hour period, subjects were given meals consistent with the standard diet for breakfast (0800), lunch (1200) and dinner (1800) and a snack at 2100 hr.

### First 5 Weeks

At the end of the baseline period subjects were discharged with meals for the next 3-4 days designed according to the LoBAG₃₀ diet (30% carbohydrate, 30% protein, 40% fat). The subjects then returned to the SDTU to meet with our research dietitian and/or clinical data coordinator at least twice each week. At that time they were weighed, provided a urine sample to determine dietary compliance, and discussed the study, foods, and menus. Subjects had a random (non-fasting) blood glucose concentration checked. They also picked up food for the next 3-4 days. Any uneaten food from the previous 3-4 days was returned and noted in the patient's record. An important aspect of the study was to keep the subjects weight stable for the 10 weeks so that any change in glucose control could be attributed to the diet, and not to a change in weight. If a subject's weight changed on 2 consecutive visits, the food provided was increased or decreased in keeping with a LoBAG₃₀ diet so that the number of calories provided should ensure weight stability.

At the end of 5 weeks, the subjects again were admitted to the SDTU to have blood drawn and urine collected over a 24-hour period for the tests indicated above, while eating a LoBAG₃₀ diet.

### Second 5 Weeks

Following the admission to the SDTU after 5 weeks, subjects again were sent home with meals for the next 3-4 days, and followed the same protocol indicated above. At the end of the second 5 weeks (10 weeks total) subjects again were admitted to the SDTU to have blood drawn and urine collected over a 24-hour period while eating a LoBAG₃₀ diet.

We also determined lean body mass and blood pressure during the hospital stays. In addition, protein balance was determined.

### Results

### Weight

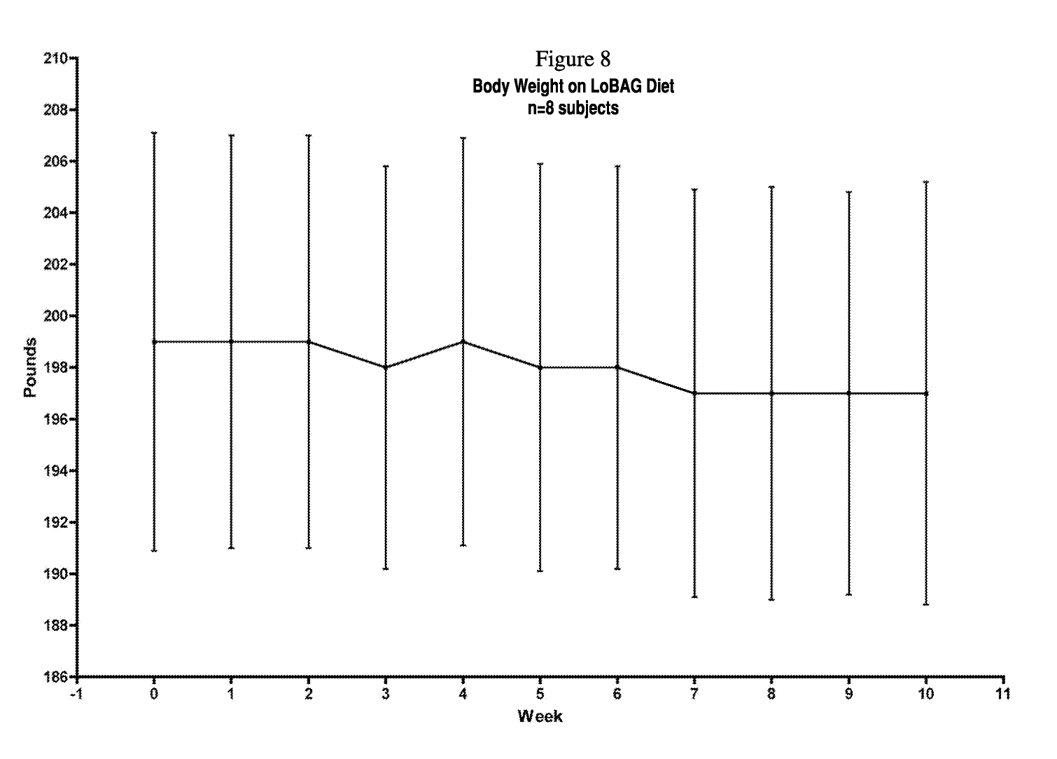

The subjects' initial mean body weight was 199 pounds. The mean final body weight was 197 pounds. Thus, the average body weight remained essentially stable during the 10-week study period (FIG. 8).

### Fasting Glucose Concentration

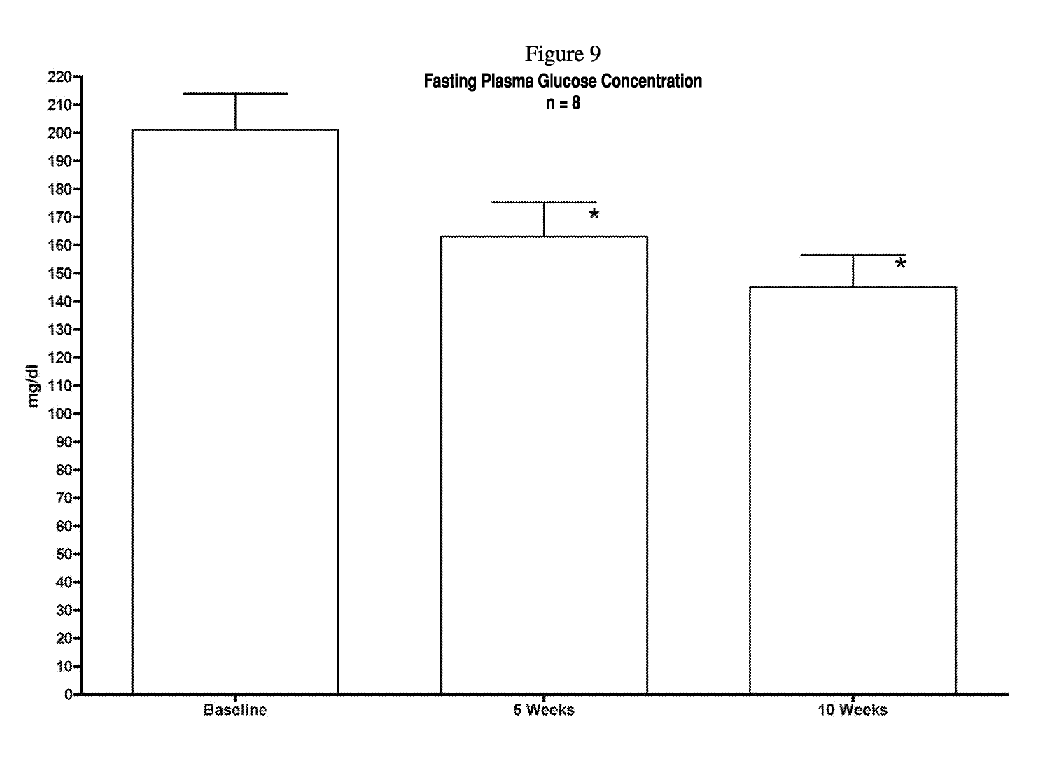

The fasting glucose concentration at the beginning of the study was 201±13.4 mg/dl. After 5 weeks on a LoBAG₃₀ diet the fasting concentration decreased to 163±12.3 mg/dl. Following another 5 weeks (10 weeks total) the fasting glucose concentration was 145±11.5 mg/dl. Thus, the fasting glucose concentration decreased by 28% after 10 weeks on a LoBAG₃₀ diet in weight-stable subjects with type 2 diabetes (FIG. 9). The differences between Baseline and 5 weeks, Baseline and 10 weeks, and 5 weeks vs 10 weeks were all statistically significant (P≦0.05).

### Random Glucose Concentration

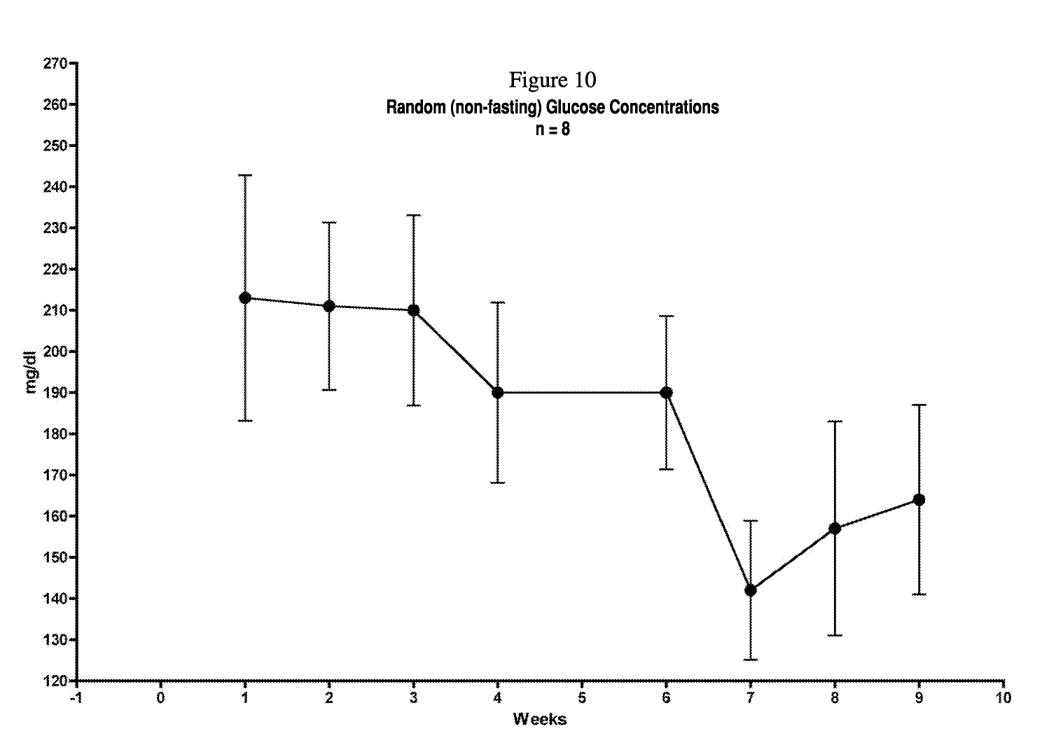

A fingerstick glucose concentration was measured, using a glucose meter, at one time when the subject visited with the research dietitian and clinical data coordinator at the twice weekly visits. These glucose concentrations were measured at various times during the day, at a time when it was convenient for the patient to come to our study unit to pick up food. While these data are much more variable that those determined while the subjects were in the SDTU for the 24 hour blood draw, and the data represent non-fasting values at various times after meals were ingested, which may have been different from week to week, the data do indicate that a non-fasting glucose concentration also decreased during the 10 week study (FIG. 10).

### 24-Hour Glucose Profiles

The 24 hour glucose profiles at Baseline, 5 weeks and 10 weeks are shown in FIG. 4. This figures demonstrates the continually decreasing fasting glucose concentration, shown at zero hour, and presented previously as a bar graph (FIG. 9). Also shown in this figure are the glucose excursions following the 3 meals (breakfast at 0 hour, lunch at hour 4, dinner at hour 10), and a snack (at hour 13).

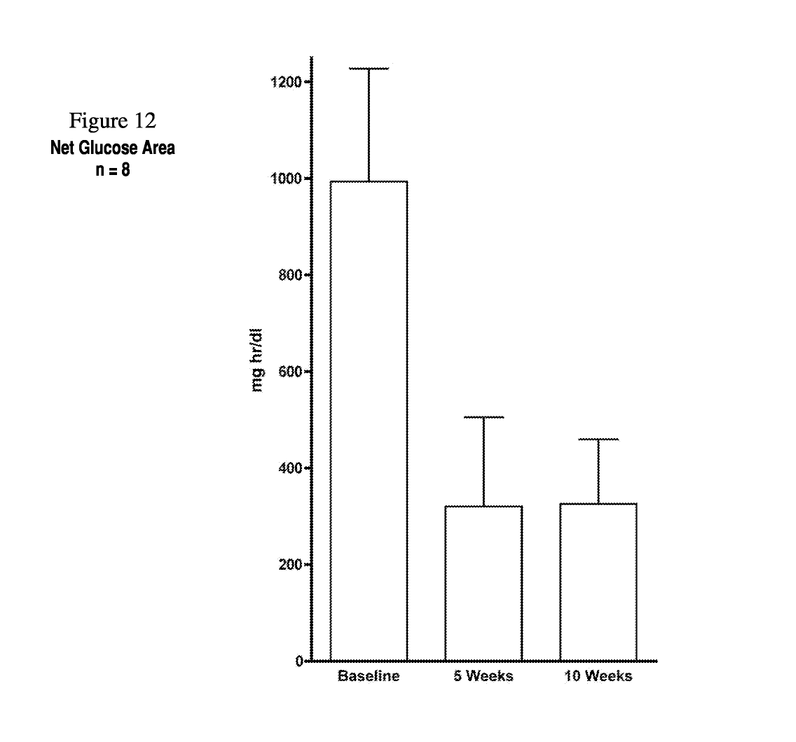

To quantify the excursions, the area under the curve was determined 2 ways. First, the area was determined using the fasting glucose as baseline. This is referred to as the “net area,” and is depicted as a bar graph (FIG. 12). The data indicate that following 5 weeks on a LoBAG₃₀ diet the net glucose area is significantly reduced. An additional 5 weeks on the diet does not reduce the area any further.

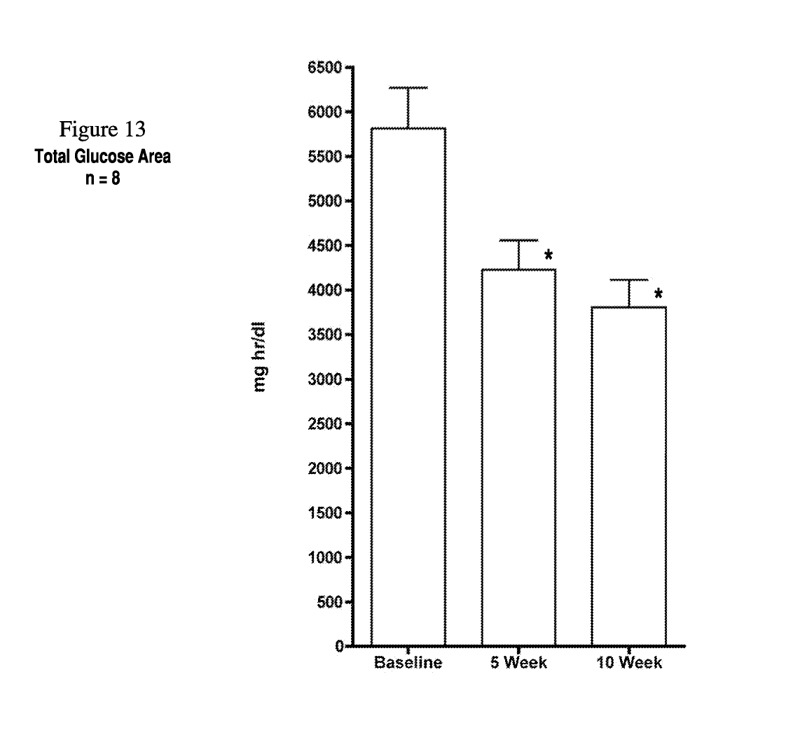

Next, the area was determined using a glucose concentration of zero as baseline. This method of quantifying the response is referred to as “total area,” and is depicted as a bar graph (FIG. 13). The data indicate that following 5 weeks on a LoBAG₃₀ diet, the total glucose area is significantly reduced. An additional 5 weeks on the diet results in a further, statistically significant decrease in response. The total glucose area decreased by 35% at week 10 compared to baseline.

% Total Glycated Hemoglobin (% tGHb)

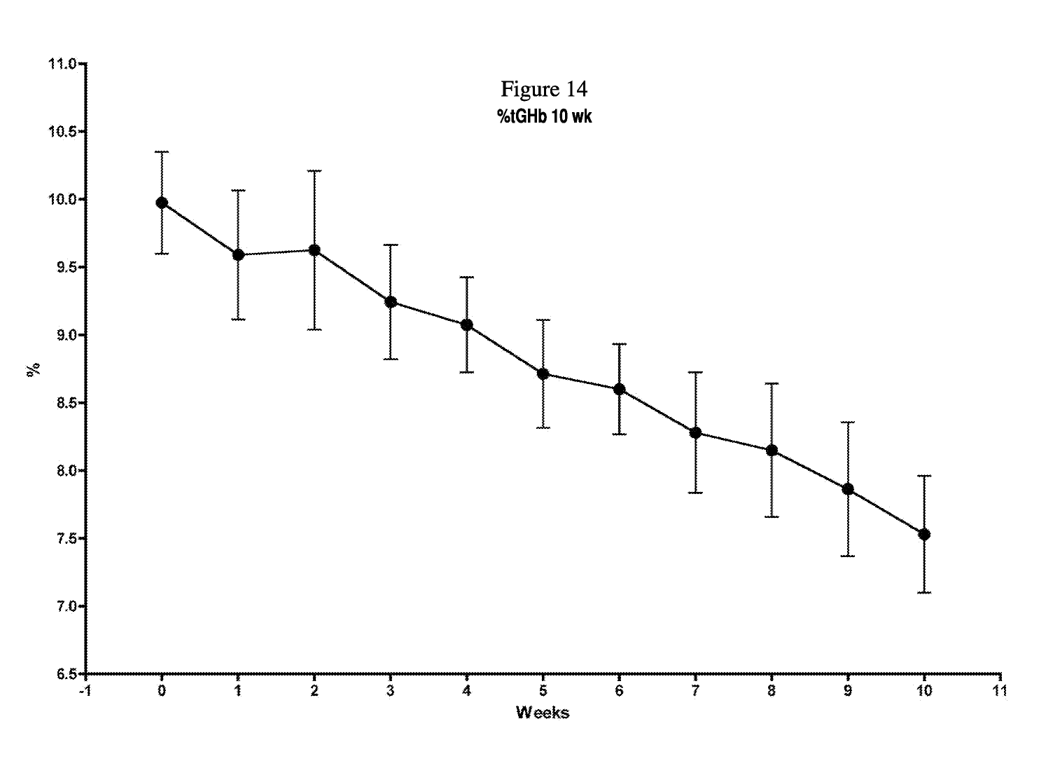

The % total glycated hemoglobin (% tGHb), at the beginning of the study was, 10±0.38%. It decreased progressively during the 10 weeks of the study. The mean % tGHb decreased by 25% at week 10 and was still decreasing linearly (FIG. 14). This was unexpected, and indicates that a metabolic adaptation occurred as a result of ingesting the diet.

### Mean Fasting Serum Insulin

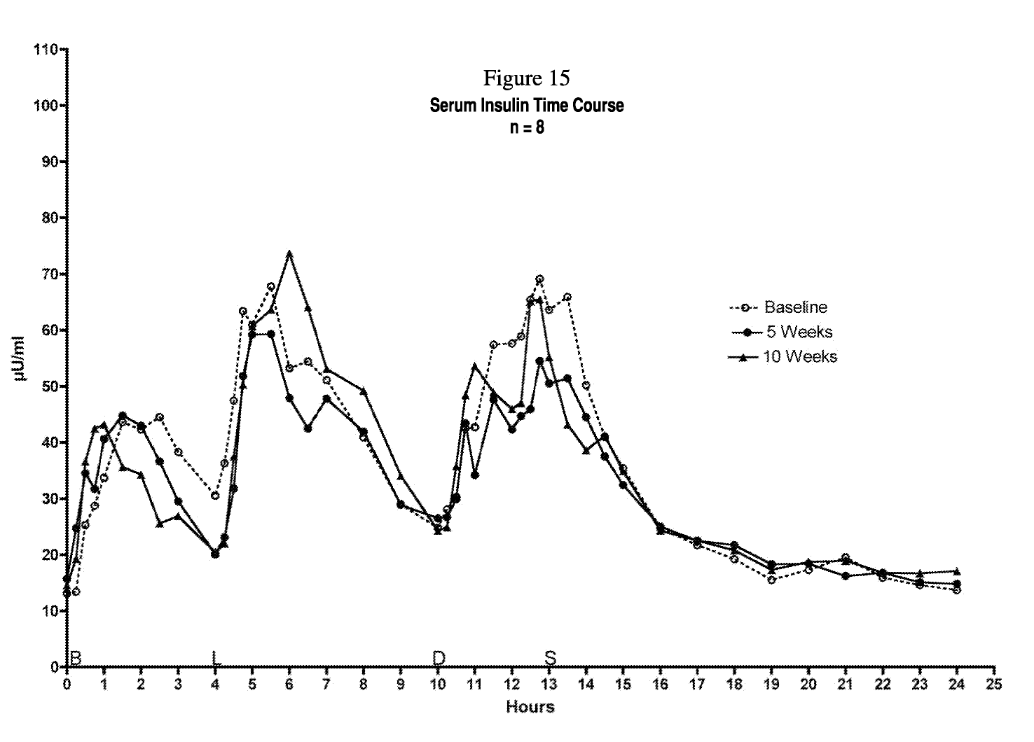

The mean fasting serum insulin concentrations were similar before and after 5 weeks and 10 weeks on the diet, as were the excursions after meals (FIG. 15). The C-peptide excursions were similar to those of insulin.

### Fasting Serum Triacylglycerol

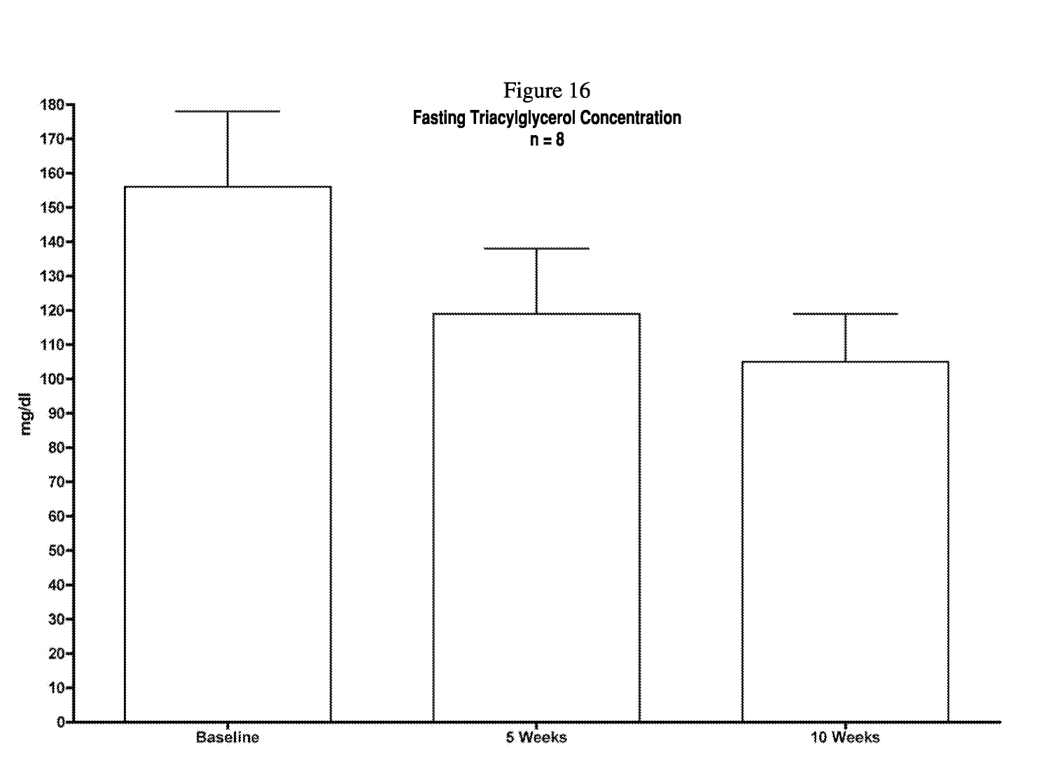

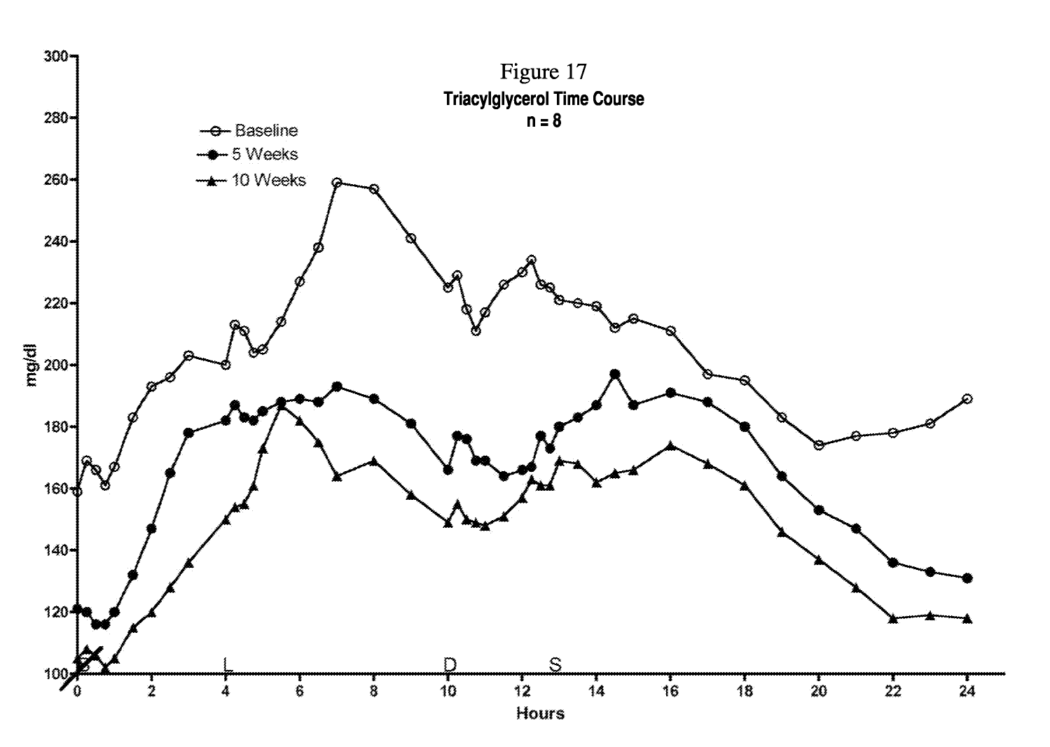

The fasting serum triacylglycerol concentration decreased progressively from a baseline of 159±22 to 119±19 mg/dl at 5 weeks and decreased further at 10 weeks to a mean of 105±14 mg/dl (FIG. 16). The differences between baseline and 5 weeks and baseline and 10 weeks were statistically significantly different (P<0.05). The 24 hour profile data indicated that the net triacylglycerol area responses were nearly identical (FIG. 17). However, the total area responses approached statistical significance (P=0.06) because of the decrease in the fasting concentration (data not shown).

### Mean Fasting Glucagon Concentration

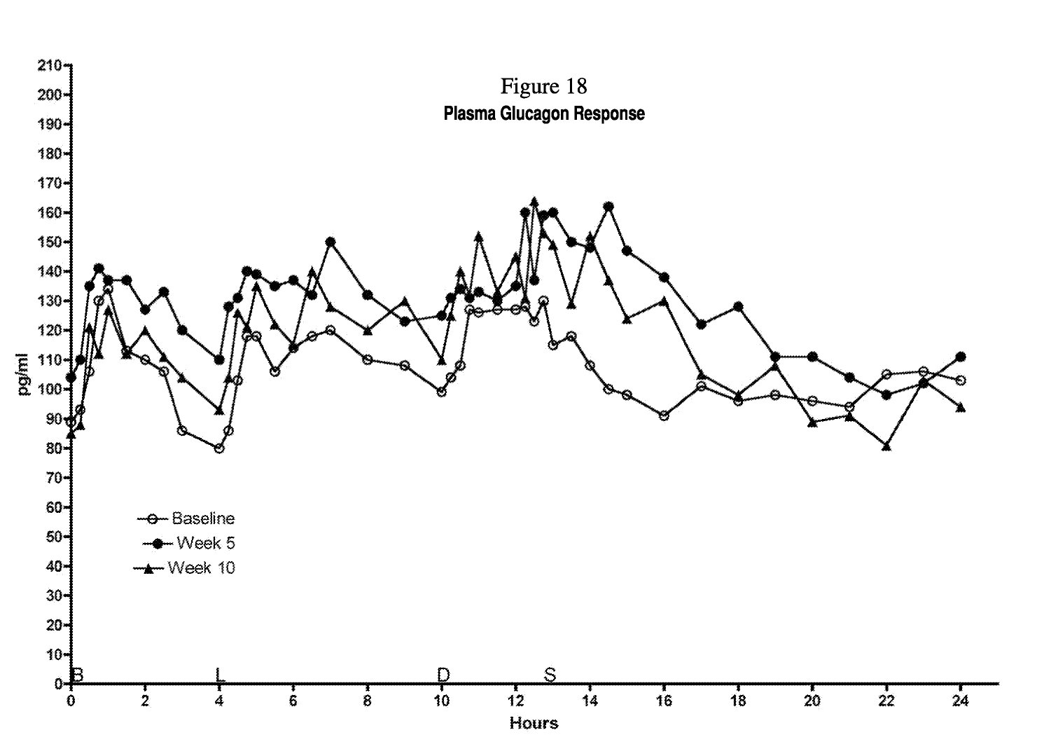

The mean fasting glucagon concentration was not significantly different at baseline, 5 weeks, or 10 weeks after the LoBAG₃₀ diet (89±20, 104±19, and 85±18 pg/ml, respectively). The 24 hour profile data (FIG. 18) indicated that the net area response increased progressively from baseline to 5 weeks, and again at 10 weeks, but these increases were not statistically significant. The total glucagon area responses were all similar.

### Mean Fasting NEFA Concentration

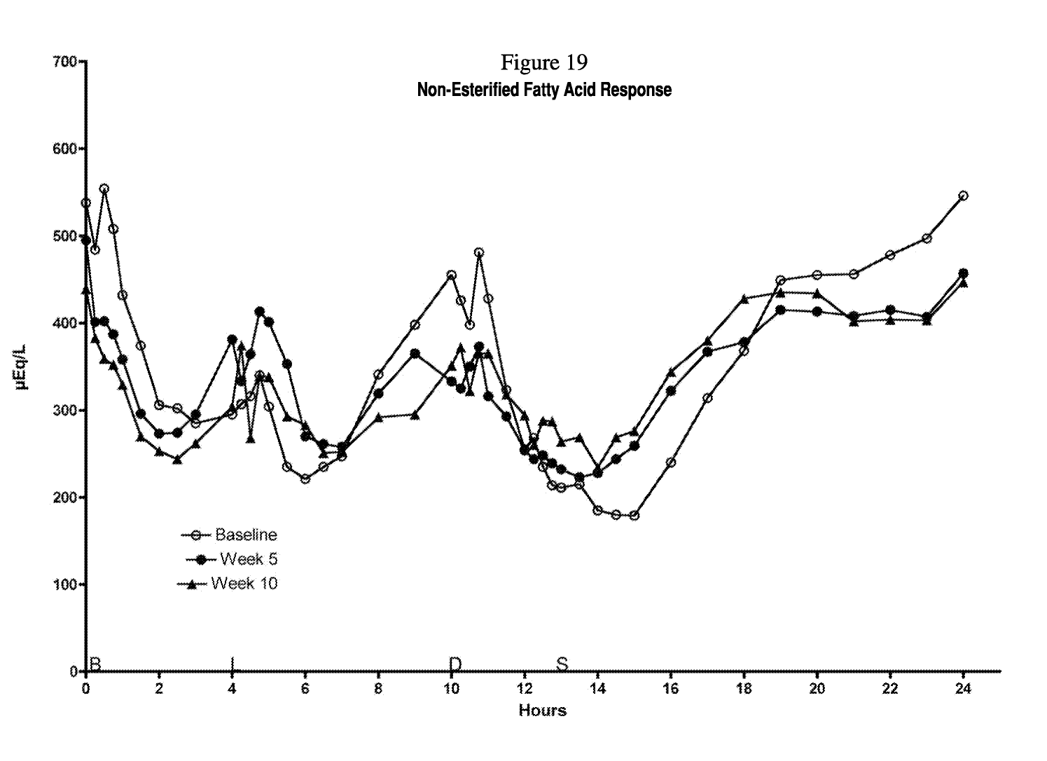

The mean fasting NEFA concentration was highest at baseline, lower after 5 weeks and lowest after 10 weeks on the diet (FIG. 19—zero time point). However, these differences were not statistically significant (P=0.51). The NEFA concentrations decreased after meals, as expected, and then transiently increased before the next meal. A nadir was reached after the evening meal, followed by a return to baseline by 0800 the following morning. Both the integrated net area and total 24-hour NEFA area responses were similar following 5 and 10 weeks on the LoBAG₃₀ diet. When the 5- & 10-week net area responses were combined and compared to the baseline area, there were no differences (p value=0.27).

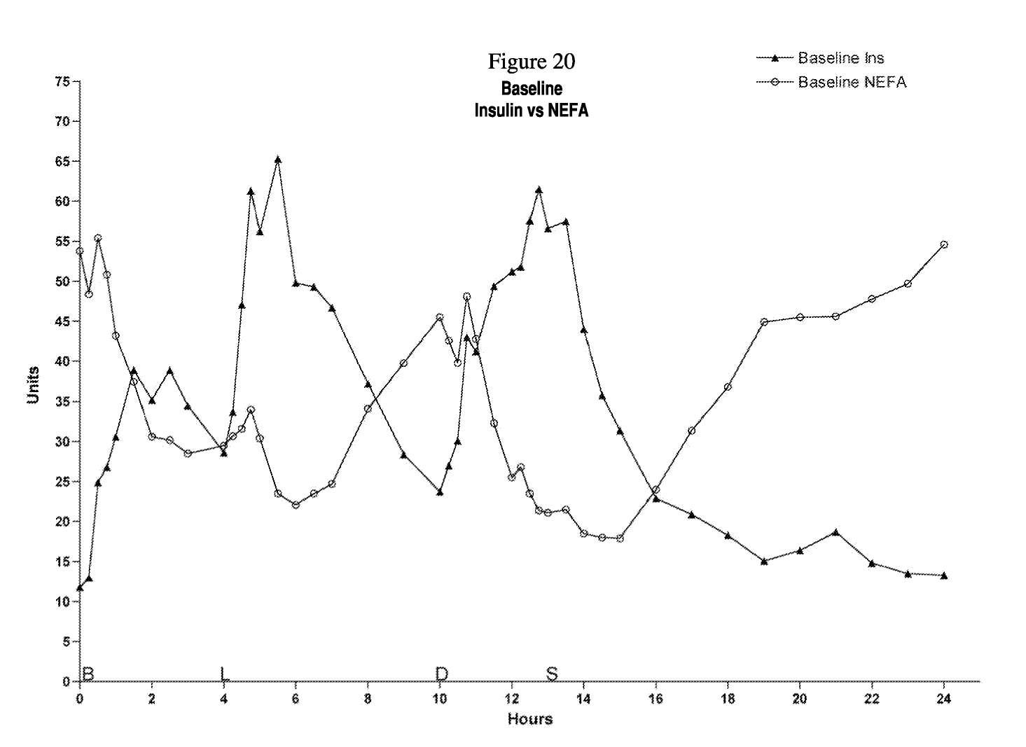

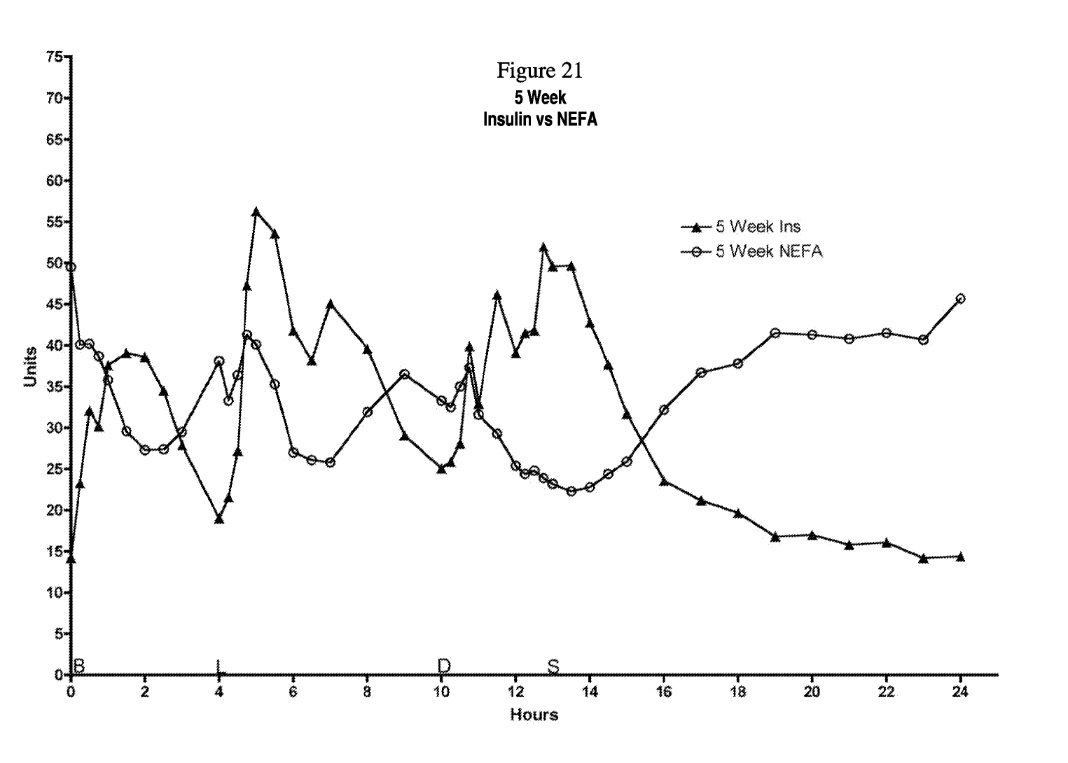

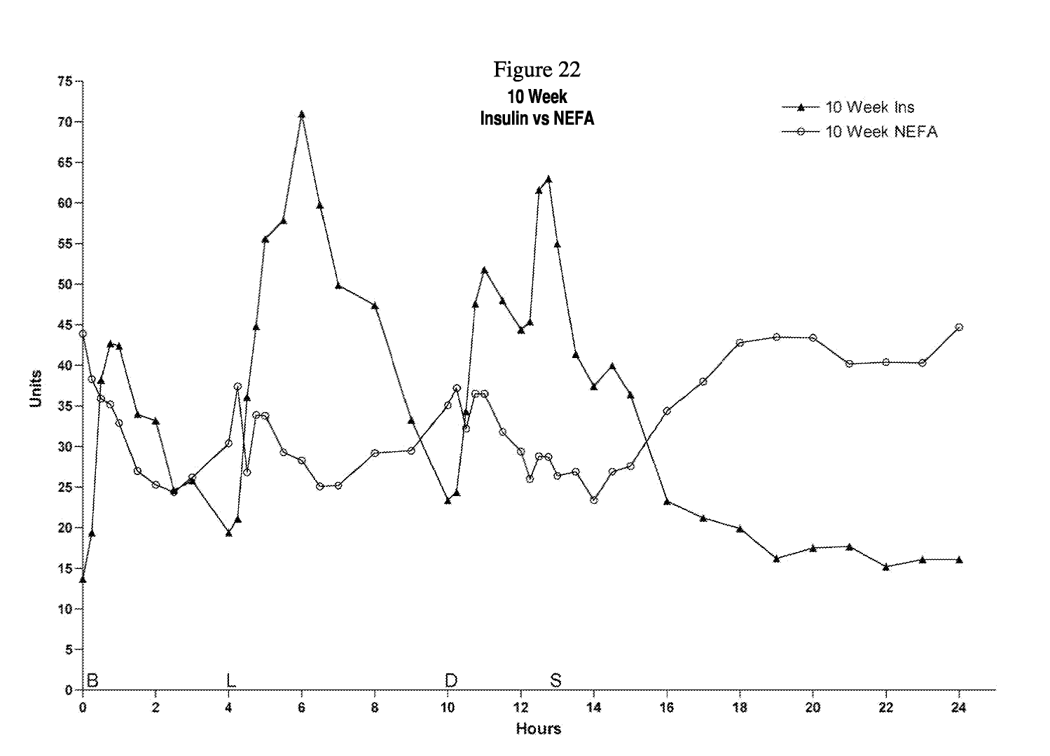

The NEFA response following meals is essentially the reciprocal of the insulin response following meals at baseline (FIG. 20), 5 weeks (FIG. 21) and 10 weeks (FIG. 22), as expected. FIGS. 20, 21 and 22 indicate that the general response for baseline, 5 weeks, and 10 weeks is that when the insulin concentration increased after meals, the NEFA concentration decreased, as expected. However, a threshold insulin concentration, above which the NEFA decreased, is not apparent. As the insulin concentration decreased after the evening meal, the NEFA concentration increased.

### Alpha Amino Acid Nitrogen

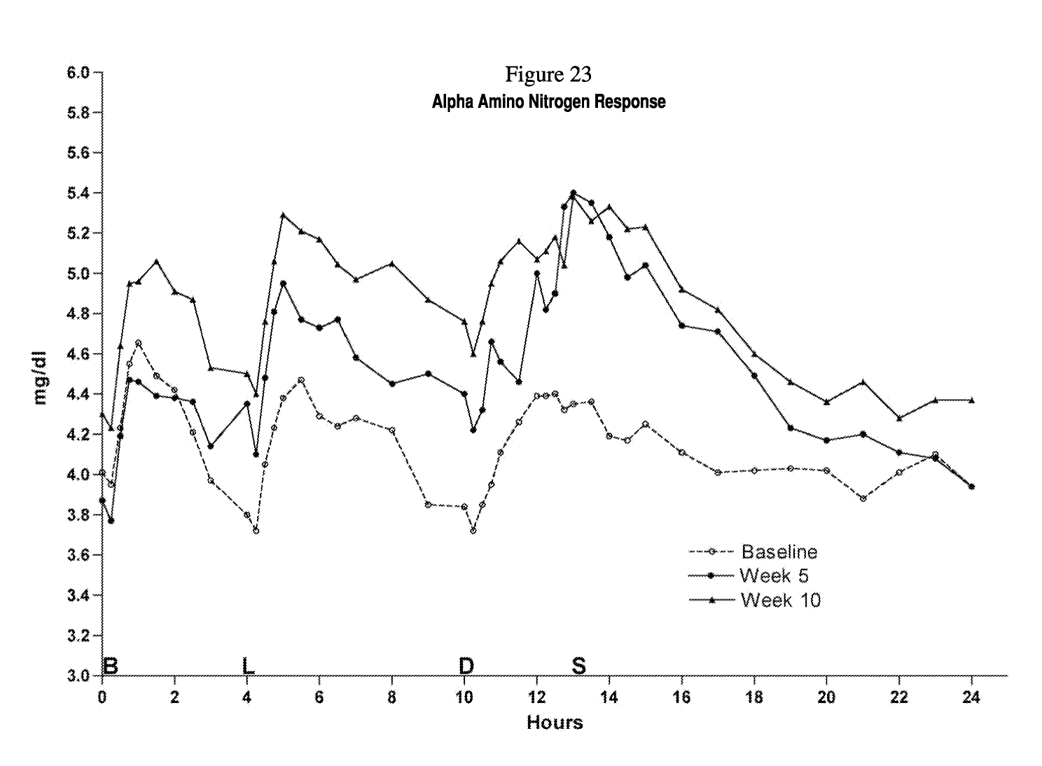

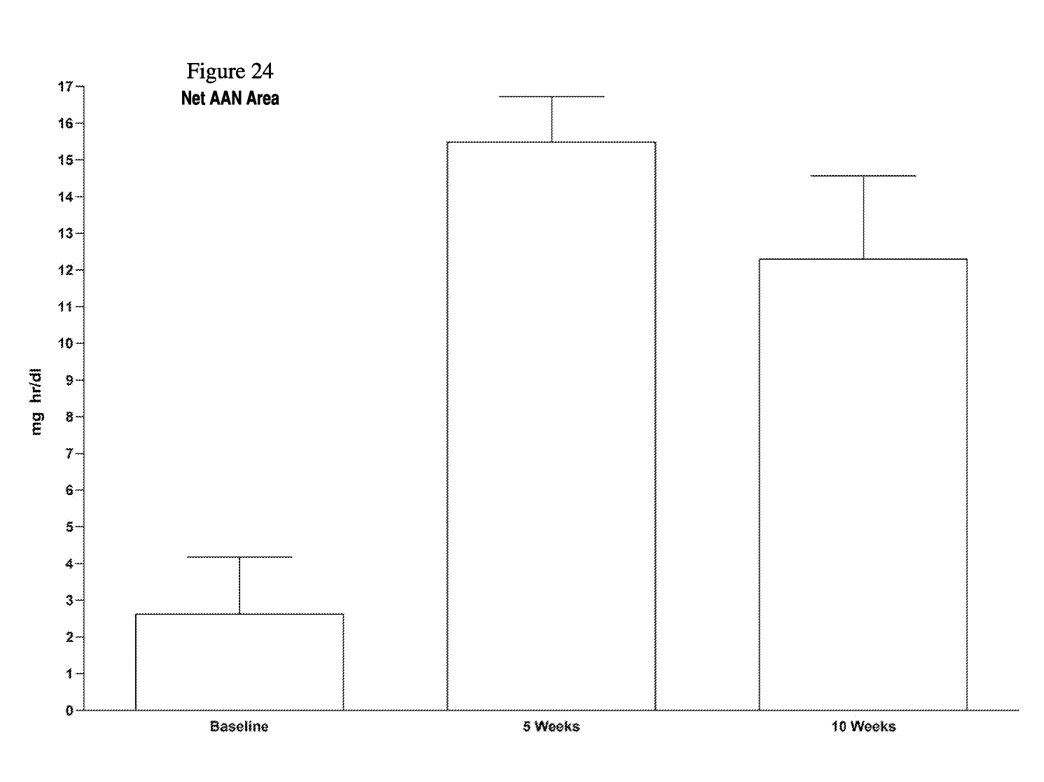

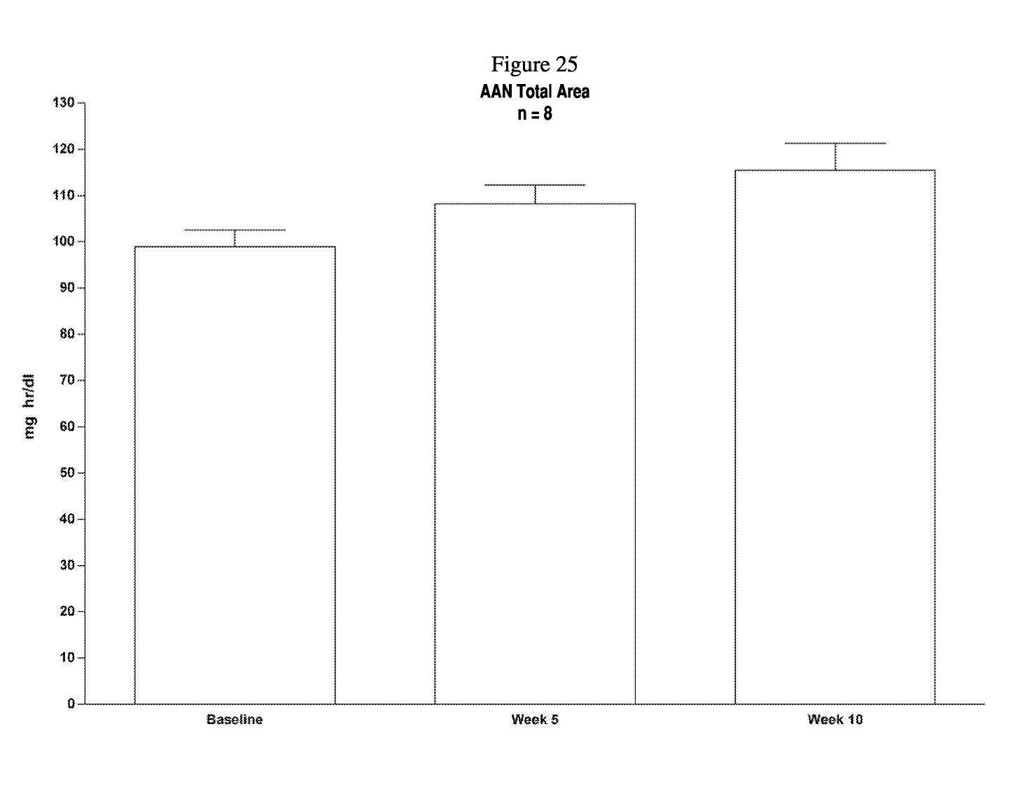

The mean fasting alpha amino acid nitrogen concentrations were similar before the diet and after 5 weeks or after 10 weeks on the diet (FIG. 23, time zero). Both the integrated net (FIG. 24) and total (FIG. 25) area responses at 5 & 10 weeks were significantly increased compared to baseline (P≦0.01). However, the net and total area responses were similar after 5 and after 10 weeks on the diet.

### Uric Acid Concentration

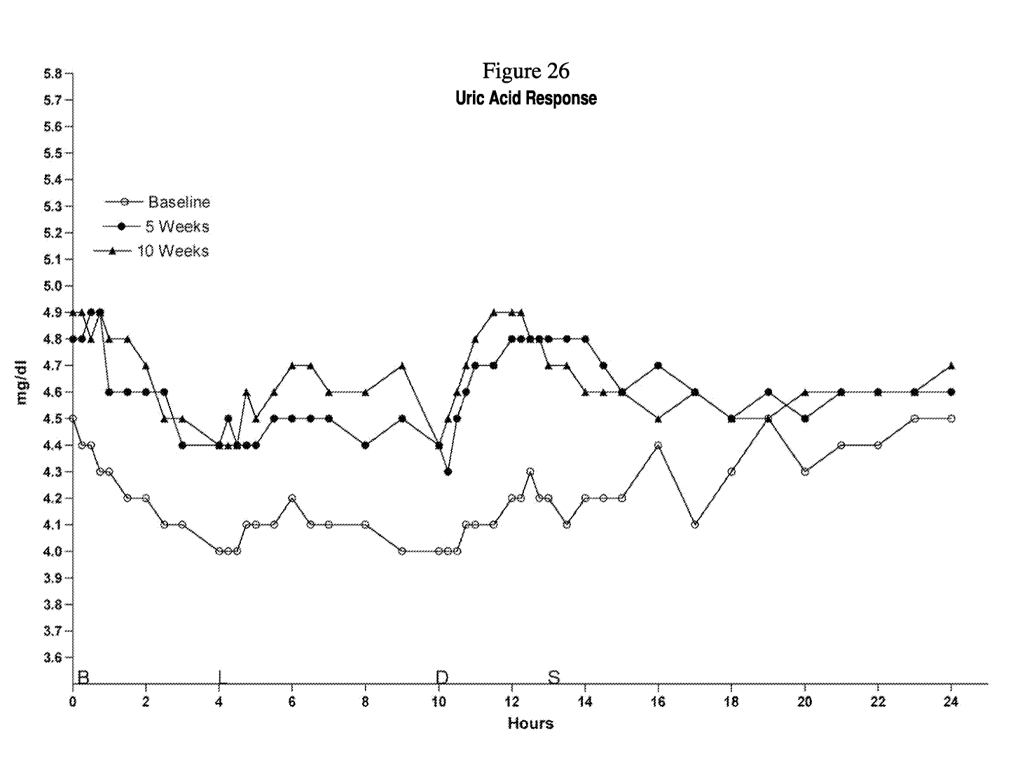

The mean fasting uric acid concentration was modestly, but not significantly higher after 5 or 10 weeks on the diet (p=0.14) (FIG. 26, zero time). In the 24-hour profiles, the uric acid concentration decreased during the day, regardless of the diet, or the length of time on the LoBAG₃₀ diet. The reason for the decrease is unknown, unless it is a dilutional effect. The net 24-hour area was negative, due to the decrease during the day, and was similar at baseline, 5 and 10 weeks. The total 24-hour areas were not statistically significantly different between baseline, 5 and 10 weeks.

### Urea Nitrogen Concentration

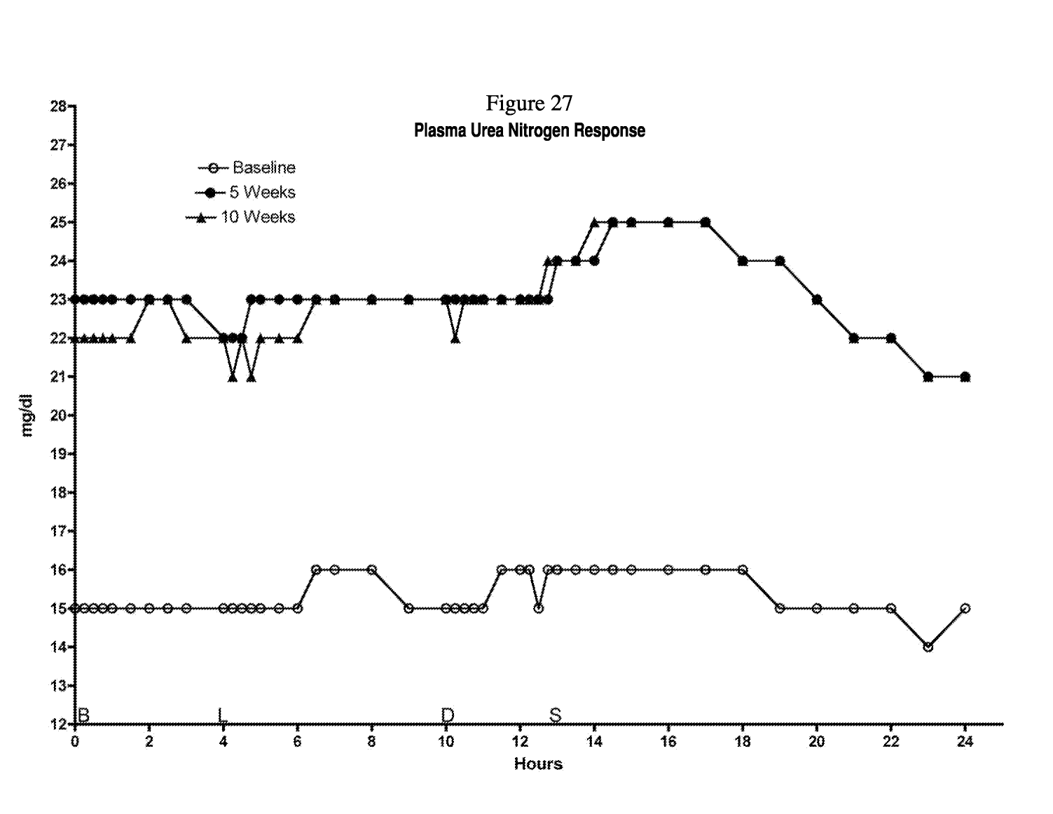

The mean fasting plasma urea nitrogen concentration was higher after 5 and 10 weeks on the diet compared to baseline (FIG. 27, zero time). The concentrations at 5 and 10 weeks were not different from one another, but were statistically significantly increased compared to baseline (P=0.004). In the 24-hour profiles, there was a very modest increase in urea nitrogen concentration during the day, with a return to baseline by 0800 the following morning. The responses at 5 and 10 weeks were nearly identical. The net 24-hour urea nitrogen area response was essentially zero at baseline, 5 and 10 weeks. The 24-hour total area increased by ˜50% after 5 and 10 weeks on the LoBAG₃₀ diet (FIG. 21). Again, the increases at 5 and 10 weeks were not different from one another, but were statistically significantly increased compared to baseline (p=0.0001).

### Protein Ingested

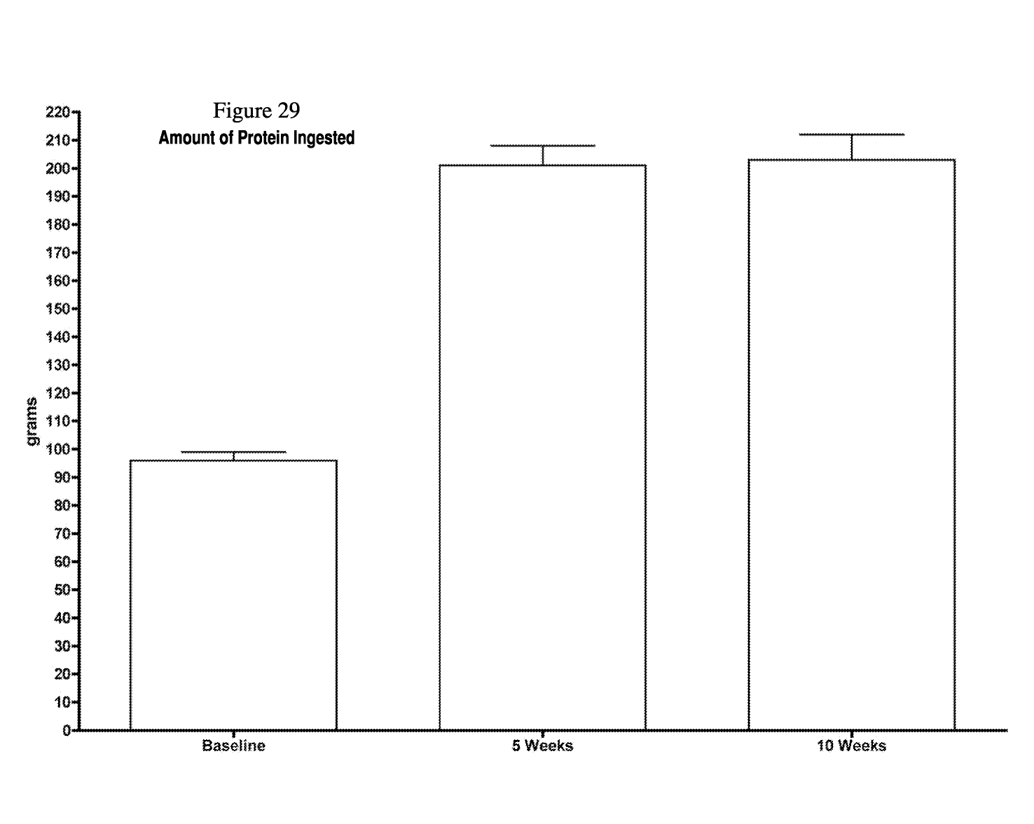

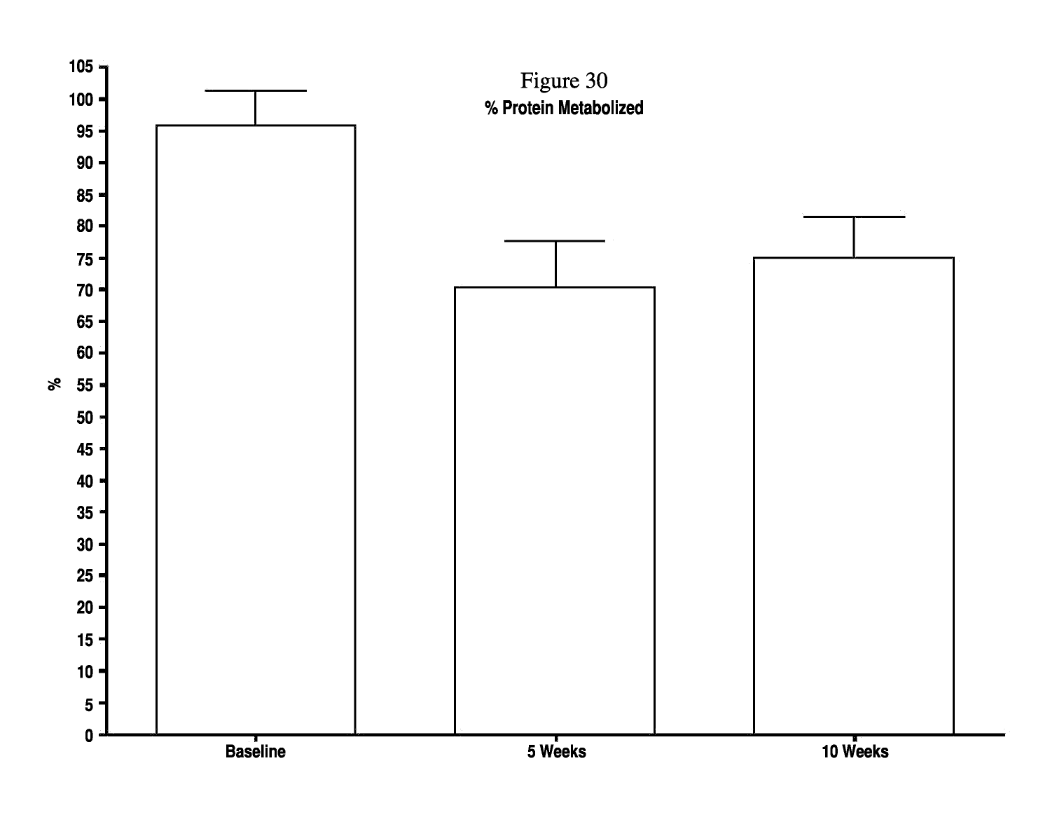

The calculated total amount of protein ingested (FIG. 29) during the 24-hour study periods at the beginning and at the end of 5 and 10 weeks was compared with the total protein metabolized. At the beginning of the study, during the first 24 hours while ingesting the control (15% protein) meals, it was calculated that 96±3 g of protein were ingested and 92±5 g were metabolized (96±5%). At the end 5 weeks on the LoBAG₃₀ diet, the calculated mean protein ingested over 24 hours was 201±7 g; that metabolized was 141±15 g (70±7%). At the end of 10 weeks, 203±9 g of protein were calculated to have been ingested and 150±12 g were calculated to have been metabolized (75±7%). Thus, the calculated percent of protein metabolized (FIG. 30) at 5 and 10 weeks after ingestion of the LoBAG₃₀ diet was similar and less than that following the control diet. Calculating the grams of protein metabolized/kg lean body mass, yielded similar results. (Baseline=1.3±0.1, 5 week=2.0±0.2, 10 week 2.2±0.1 g/kg lean body mass).

### IGF-I Concentration

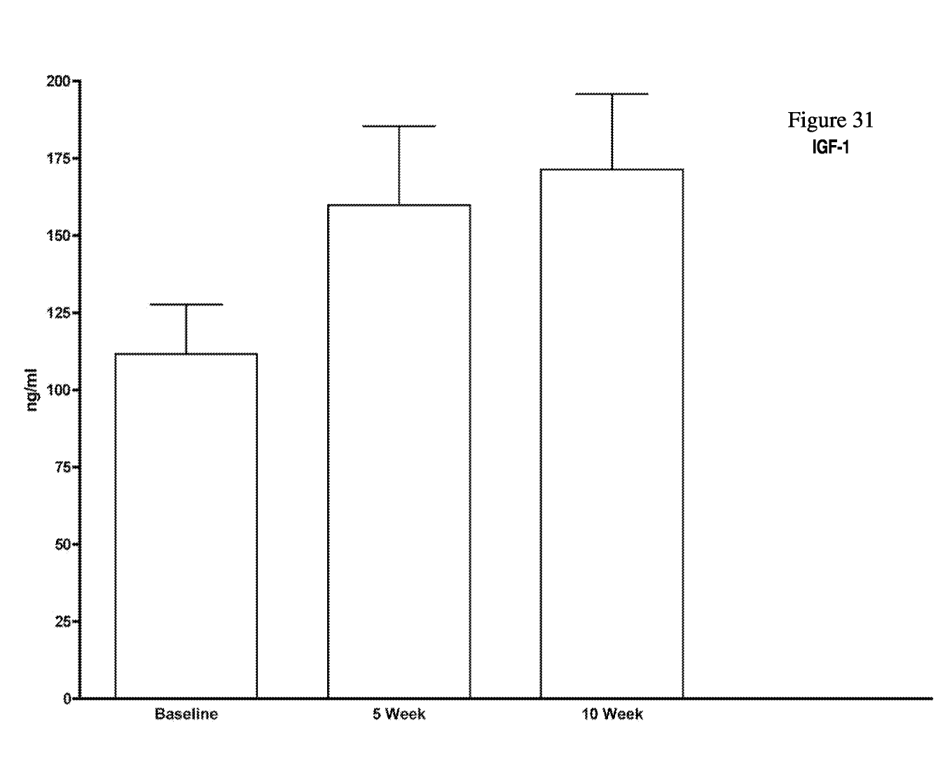

The fasting serum IGF-I concentration was significantly higher after ingestion of the diet, from a mean at baseline of 112±16 to 160±26 at 5 weeks and to 171±25 ng/ml 10 weeks (FIG. 31). The difference between the 5 and 10-week values was statistically significant (p=0.01), and both were significantly increased compared to baseline (P≦0.004 and p≦0.0008, respectively).

### Fasting Serum Cholesterol Concentration

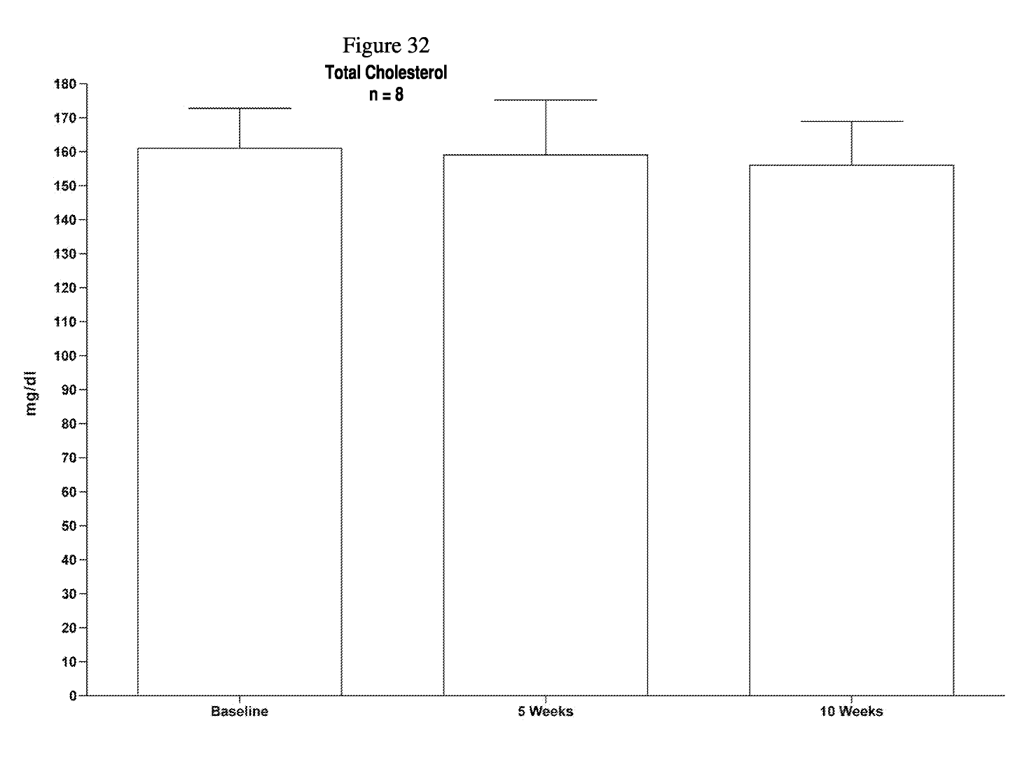

The fasting serum cholesterol concentration was 161±12 mg/dl at Baseline, 159±16 mg/dl after ingesting a LoBAG 10 for 5 weeks, and 156±13 mg/dl after ingesting a LoBAG diet for 10 weeks (FIG. 32). Thus, a LoBAG diet does not have deleterious effects on serum cholesterol.

### Serum Albumin

Serum albumin was modestly higher at week 5 compared to baseline or week 10 (Table 9, below). The increase at week 5 was similar to the statistically significant increase we reported previously (Reference 13). Prealbumin was only modestly higher at week 5 and similar to baseline at week 10. The TSH, total T₃, free T₄, B₁₂, folate, homocysteine, growth hormone and renin were similar at baseline, 5 and 10 weeks. None of the minor differences in hormones and metabolites noted above were statistically significant. The LDL and HDL cholesterol remained essentially unchanged over the 10 weeks of the study. The serum creatinine concentration was identical at baseline, 5 weeks and 10 weeks.

### Urine Volume and Sodium Excretion

The total urine volume and sodium excretion were modestly greater at 5 weeks and further increased at 10 weeks compared to baseline (Table 9). Potassium excretion was little changed. Urinary calcium excretion was modestly less after 5 weeks on the diet and remained lower than the baseline value at 10 weeks, but this was not statistically significant. Urinary glucose excretion decreased significantly after 5 weeks on the LoBAG₃₀ diet, as we reported previously, and as expected (Reference 13). It was decreased further after 10 weeks, however the difference between weeks 5 and 10 was not statistically significant. Creatinine excretion was little changed. Urea nitrogen excretion increased significantly after 5 weeks on the diet, as we reported previously (Reference 13). It decreased very modestly, although significantly at week 10 compared to week 5 (p=0.01). Uric acid excretion was increased after 5 weeks on the diet, again confirming our previous data (Reference 13). It then decreased modestly, but not significantly at 10 weeks. Only three of the subjects had measurable urinary microalbumin at the beginning of the study. Two of the three subjects urinary micro-albumin was unmeasurable by 10 weeks.

Both the systolic and the diastolic blood pressures were unchanged (Table 9).

### Urine pH and Urine Calcium

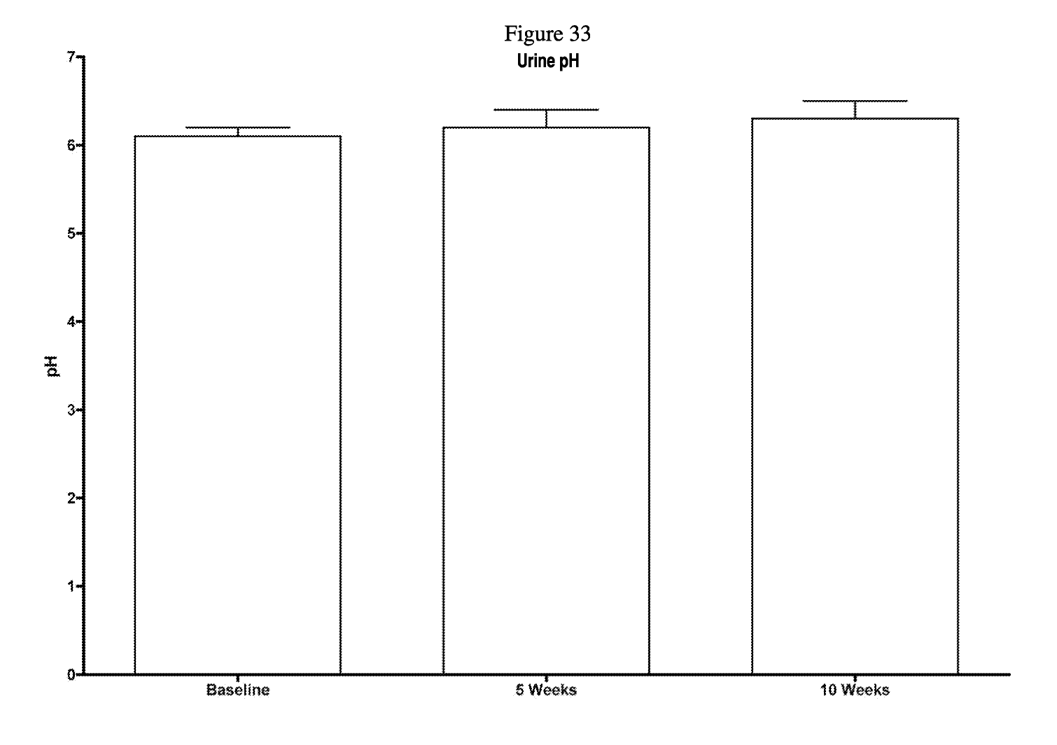

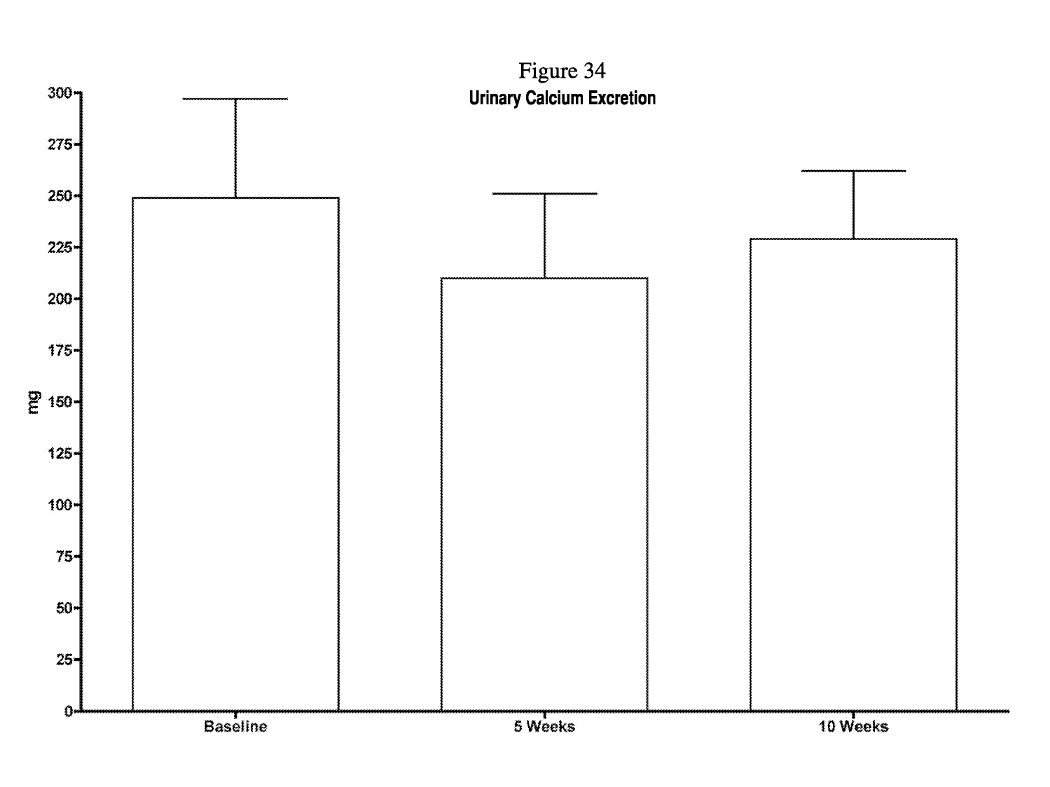

There was no effect on loss of body calcium as measured by urine pH (FIG. 33) and urine calcium (FIG. 34). Adverse effect on bone, due to a loss of body calcium has been used as a criticism of a higher protein diet (Reference 14).

### Creatinine Clearance

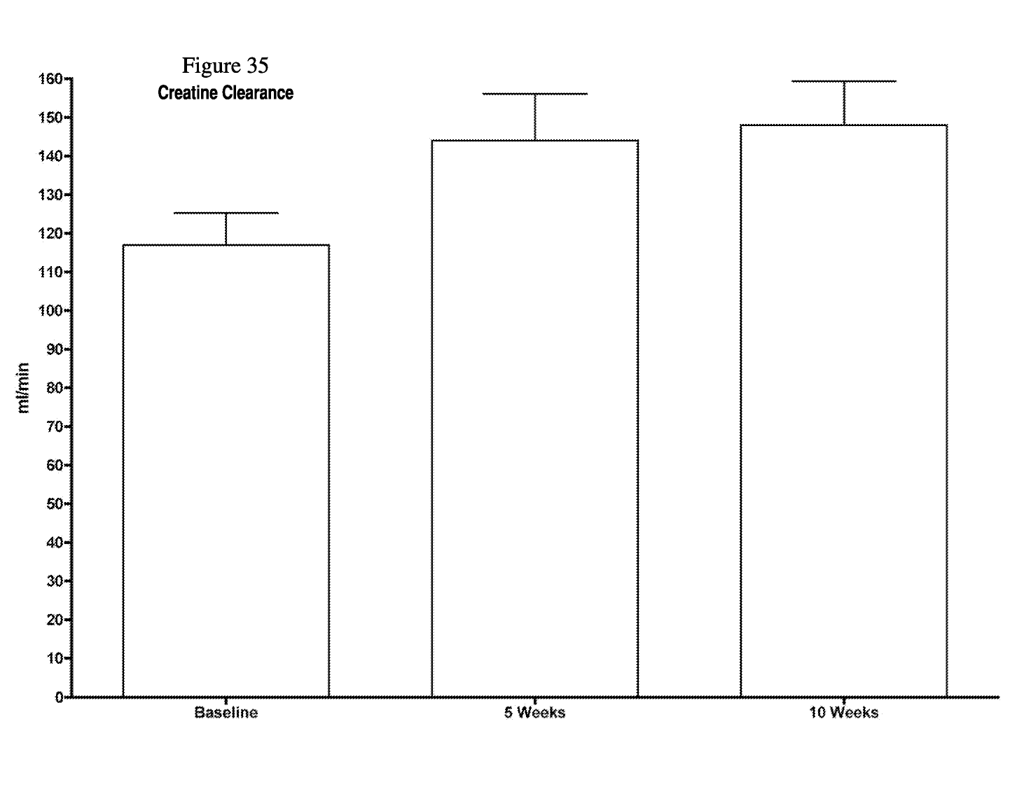

There was no change in creatinine clearance, which is used as an indicator of kidney function, between weeks 5 and 10 (FIG. 35).

### Nine to 26 Week Study in which Food was not Provided

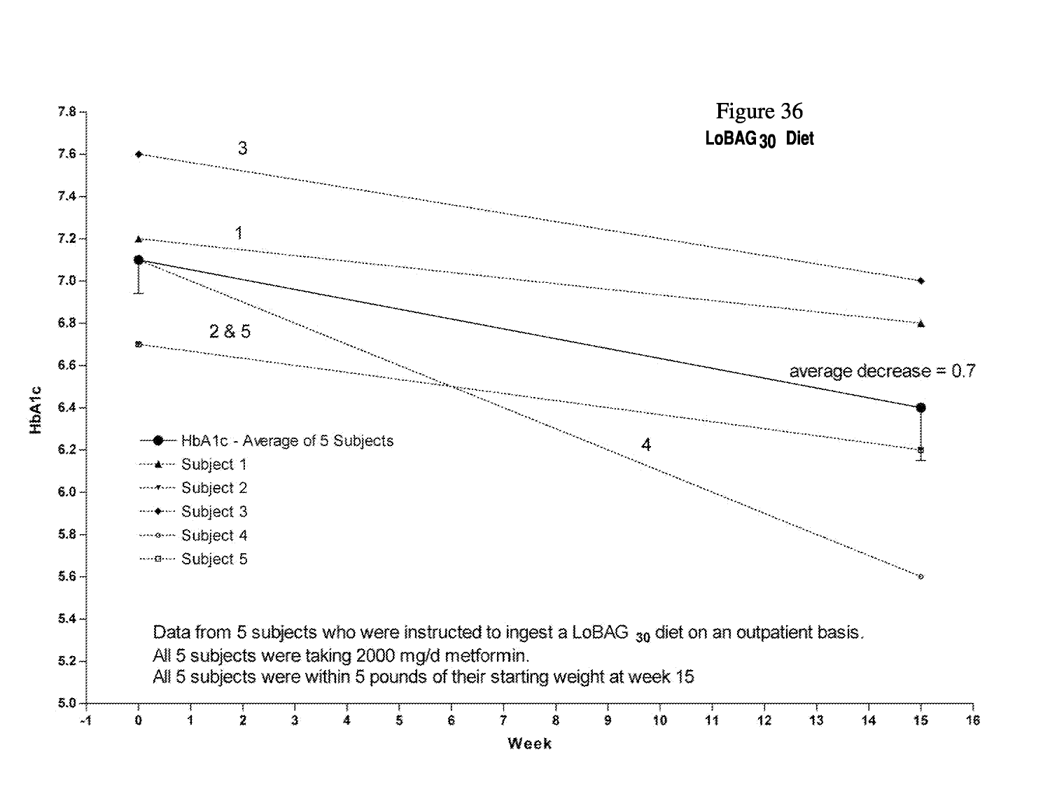

The next study (FIG. 36) was designed to determine whether subjects would follow a LoBAG diet when they were required to purchase and prepare their own meals. In the previous studies we provided all of the food. In this study we also wanted to determine whether a LoBAG diet could improve blood glucose control, as evidenced by HbA1c values, when subjects with type 2 diabetes were being treated for their disease with a commonly prescribed hypoglycemic agent, metformin.

Subjects met with our research dietitian and/or our clinical data coordinator on a weekly basis. At these meetings, the subjects provided a urine sample for measurement of urea and creatinine to determine dietary compliance, and the meal plans, and food choices were discussed.

Data are presented for 5 subjects who remained within 5 pounds of their starting weight, and in whom the urine urea:creatinine ratio was 9 or above. The weight restriction was set because a change in weight may affect diabetes control. (Several subjects lost weight, which may be an added benefit of the diet.) Thus, we are presenting only data for subjects within 5 pounds of their starting weight. The urea:creatinine ratio was set to include only those individuals who were compliant in following the diet, as best we could document. In the 5 subjects who met the inclusion criteria for this application:

The HbA1c decreased significantly from 7.1±0.2% to 6.4±0.3% (p=0.02). The length of time on the diet from beginning to nadir ranged from 9 weeks to 20 weeks, with a mean of 15 weeks.

These data indicate that a LoBAG diet is effective in lowering HbA1c in people with type 2 diabetes when:

a) subjects follow the diet for 9 weeks or longer

b) subjects select, purchase and prepare their own food

c) subjects remain weight stable (±5 pounds)

d) subjects are being treated for their diabetes with a maximum dose (2000 mg/day) of metformin, a commonly prescribed hypoglycemic agent

e) subjects begin the study with a relatively low HbA1c. This is important because the higher the HbA1c, the greater the possible improvement with any treatment, so beginning with a lower HbA1c biases any potential positive effect of the diet against our claim.

### One Year Data from a Free-Living Subject with Minimal Contact with Study Team

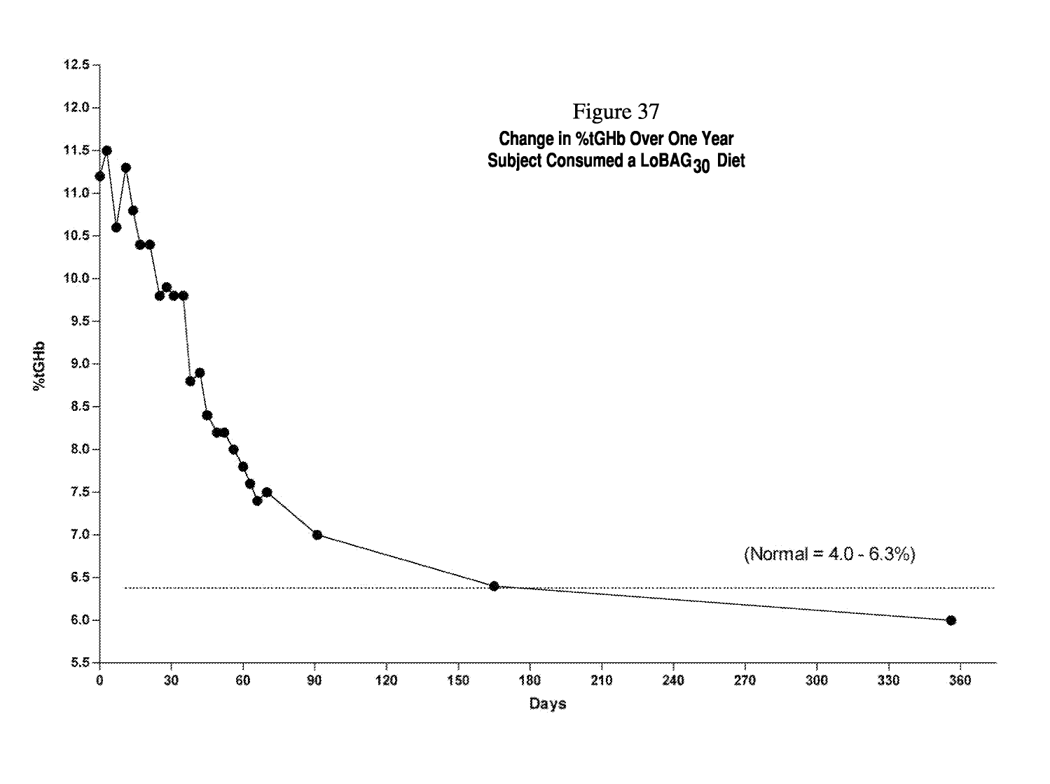

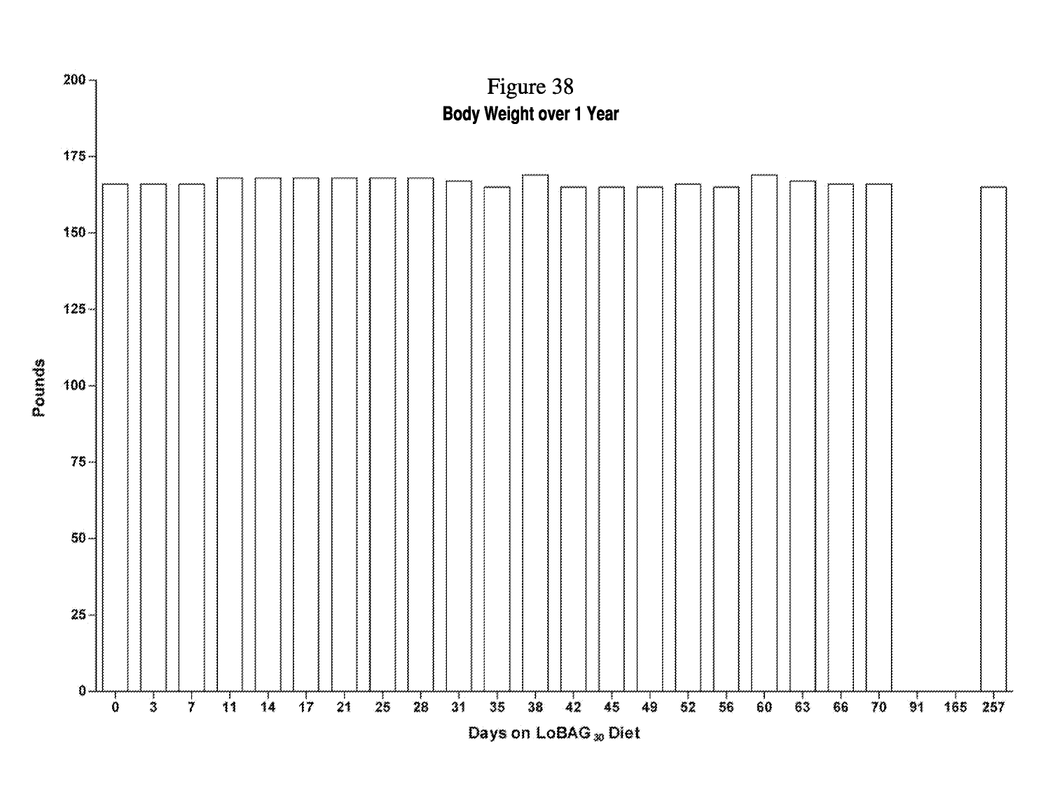

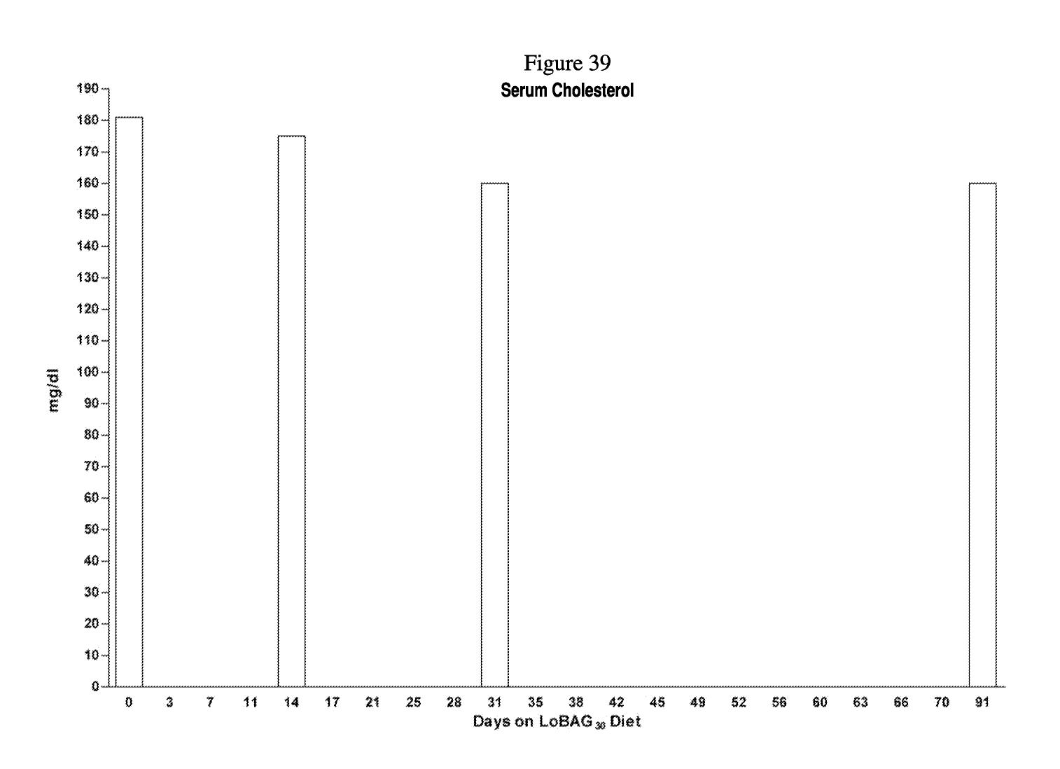

One subject who participated in our 10-week study decided to follow the diet on his own. He was seen periodically in our Diabetes Clinic, so we were able to document his glycated hemoglobin (tGHb) results for an entire year. His body weight and serum cholesterol also were recorded. His initial tGHb was 11.2%. At the end of one year it was below 6%, which is within the normal reference range (FIG. 37). He was not taking any diabetes medication at any time during that year. His body weight was stable (FIG. 38) and his cholesterol was essentially unchanged (FIG. 39).

TABLE 8
Patient Characteristics

| | | Ht | Ht | Wt | Wt | | % | Duration | Concomitant | |
|---|---|---|---|---|---|---|---|---|---|---|
| Subject | Age | Inches | Cm | Lb | Kg | BMI | tGHb | T2DM | Diseases | Medications |
| 1 | 67 | 70 | 177.8 | 208.2 | 94.5 | 29.9 | 9.7 | 3 yr | HT, BPH, | terzosin, omeprazole, |
| | | | | | | | | | osteoarthritis, | finisteride, ASA |
| | | | | | | | | | gout, GERD | |
| 2 | 65 | 70 | 177.8 | 165.8 | 75.3 | 23.8 | 11.2 | 4 yr | HT, TBI | none |
| 3 | 58 | 70 | 177.8 | 241.2 | 109.5 | 34.6 | 9.3 | 4 yr | HT, DJD, | lisinopril, ranitidine, |
| | | | | | | | | | hyperlipidemia | simvastatin |
| 4 | 67 | 65.5 | 166.4 | 181.4 | 82.4 | 29.8 | 10.2 | 4 yr | HT, hyperlipidemia | gemfibrozil, losartan |
| 5 | 60 | 71 | 180.3 | 185.0 | 84.0 | 25.8 | 9.8 | 5 yr | HT, hyperlipidemia | calcium/vit D, lisinopril, |
| | | | | | | | | | | simvastatin, naproxan, |
| | | | | | | | | | | testosterone |
| 6 | 69 | 68 | 172.7 | 183.4 | 83.3 | 27.9 | 8.6 | 6 yr | HT, osteoarthritis, | lisinopril, amlodipine, |
| | | | | | | | | | TIA, | atenolol |
| | | | | | | | | | hypercholesterolemia | |
| 7 | 48 | 66 | 167.6 | 200.4 | 92.4 | 32.8 | 9.2 | 2 yr | HT | lisinopril |
| 8 | 69 | 70 | 177.8 | 206.6 | 93.8 | 29.7 | 11.8 | 5 yr | HT, BPH, back pain | losartan, naproxan |

Abbreviations:
HT: hypertension
BPH: benign prostatic hypertrophy
TBI: traumatic brain injury
DJD: degenerative joint disease
TIA: transient ischemic attack
GERD: gastro-esophageal reflux disease

TABLE 9
Hormone and Metabolite Data

| Test | Baseline | 5 Weeks | 10 Weeks | p value |
|---|---|---|---|---|
| Serum or Plasma | | | | |
| Albumin (g/dl) | 4.4 ± 0.1 | 4.8 ± 0.1 | 4.5 ± 01 | 0.02** |
| Pre-Albumin | 21.3 ± 11 | 24.1 ± 1.9 | 22.3 ± 1.5 | 0.18 |
| (mg/dl) | | | | |
| TSH (μIU/ml) | 1.67 ± 0.25 | 1.46 ± 0.20 | 1.59 ± 0.24 | 0.03** |
| Total T₃ ng/dl | 88.9 ± 4.06 | 86.3 ± 4.01 | 94.0 ± 3.51 | 0.04** |
| Free T₄ (ng/dl) | 0.97 ± 0.08 | 0.97 ± 0.03 | 0.93 ± 0.05 | 0.20 |
| B₁₂ (pg/ml) | 316 ± 45 | 346 ± 49 | 336 ± 53 | 0.37 |
| Folate (ng/ml) | 14.9 ± 1.5 | 14.9 ± 1.5 | 13.3 ± 1.3 | 0.09 |
| Homocysteine | 138 ± 13.0 | 146 ± 10.4 | 139 ± 18.0 | 0.24 |
| (μg/dl) | | | | |
| Growth Hormone | 0.2 ± 0.03 | 0.2 ± 0.06 | 0.3 ± 1.0 | 0.16 |
| (ng/ml) | | | | |
| Renin (ng/ml) | 0.83 ± 0.34 | 0.99 ± 0.37 | 1.18 ± 0.75 | 0.29 |
| LDL-Cholesterol | 97 ± 9 | 105 ± 14 | 103 ± 11 | 0.88 |
| (mg/dl) | | | | |
| HDL-Cholesterol | 32 ± 2 | 31 ± 1 | 32 ± 2 | 0.93 |
| (mg/dl) | | | | |
| Creatinine | 1.0 ± 0.03 | 1.0 ± 0.04 | 1.0 ± 0.04 | 0.09 |
| (mg/dl) | | | | |
| Urine | | | | |
| Volume (ml) | 3670 ± 494 | 3811 ± 633 | 4197 ± 689 | 0.11 |
| Sodium (mg) | 5451 ± 759 | 6417 ± 690 | 7337 ± 1139 | 0.06 |
| Potassium (mg) | 3822 ± 335 | 4017 ± 359 | 3900 ± 319 | 0.31 |
| Calcium (mg) | 249 ± 48 | 210 ± 41 | 229 ± 33 | 0.28 |
| Glucose (g) | 33.3 ± 13.2 | 5.4 ± 3.6 | 2.8 ± 1.8 | 0.15 |
| Creatinine (mg) | 1724 ± 113 | 2109 ± 173 | 2076 ± 209 | 0.37 |
| Urea Nitrogen(g) | 13.1 ± 0.8 | 22.3 ± 1.5 | 21.6 ± 1.8 | 0.01* |
| Uric Acid (mg) | 720 ± 43 | 971 ± 59 | 957 ± 75 | 0.37 |
| Microalbumin | 9 ± 3.4 | 6 ± 1.0 | 5 ± 0.2 | 0.13 |
| (mg) | | | | |
| Blood Pressure | | | | |
| Systolic (mmHg) | 135 ± 4 | 135 ± 5 | 136 ± 4 | 0.99 |
| Diastolic (mmHg) | 82 ± 3 | 82 ± 4 | 74 ± 3 | 0.15 |

TSH = thyroid stimulating hormone
Total T3 = Total triiodothyronine
Free T4 = Free thyroxine
P values: **indicates statistical significance between 5 week data vs 10 week data
*indicates statistical significance between baseline and 5 week data as well as baseline and 10 week data

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

While this invention has been described as having preferred sequences, ranges, ratios, steps, materials, structures, components, features, and/or designs, it is understood that it is capable of further modifications, uses, and/or adaptations of the invention following in general the principle of the invention, and including such departures from the present disclosure as those come within the known or customary practice in the art to which the invention pertains, and as may be applied to the central features hereinbefore set forth, and fall within the scope of the invention and of the limits of the appended claims.

### REFERENCES

The following references, and those cited in the disclosure herein, are hereby incorporated herein in their entirety by reference.
1. Nuttall F Q, Khan M A, Gannon M C. Peripheral glucose appearance rate following fructose ingestion in normal subjects. Metabolism 2000; 49(12):1565-71.
2. Gannon M C, Khan M A, Nuttall F Q. Glucose appearance rate after the ingestion of galactose. Metabolism 2001; 50(1):93-8.
3. Nuttall F Q, Mooradian A D, Gannon M C, Billington C, Krezowski P. Effect of protein ingestion on the glucose and insulin response to a standardized oral glucose load. Diabetes Care 1984; 7(5):465-70.
4. Krezowski P A, Nuttall F Q, Gannon M C, Bartosh N H. The effect of protein ingestion on the metabolic response to oral glucose in normal individuals. Am J Clin Nutr 1986; 44(6):847-56.
5. Gannon M C, Nuttall F Q, Neil B J, Westphal S A. The insulin and glucose responses to meals of glucose plus various proteins in type II diabetic subjects. Metabolism 1988; 37(11):1081-8.
6. Khan M A, Gannon M C, Nuttall F Q. Glucose appearance rate following protein ingestion in normal subjects. J Am Coll Nutr 1992; 11(6):701-6.
7. Gannon M C, Nuttall J A, Damberg G, Gupta V, Nuttall F Q. Effect of protein ingestion on the glucose appearance rate in people with type 2 diabetes. J Clin Endocrinol Metab 2001;86(3): 1040-7.
8. Gannon M C, Nuttall F Q, Saeed A, Jordan K, Hoover H. An increase in dietary protein improves the blood glucose response in persons with type 2 diabetes. Am J Clin Nutr 2003; 78(4):734-41.
9. Gannon M C, Nuttall F Q. Effect of a high-protein, low-carbohydrate diet on blood glucose control in people with type 2 diabetes. Diabetes 2004; 53(9):2375-82.
10. Nuttall F Q, Schweim K, Hoover H, Gannon M C. Effect of the LoBAG30 diet on blood glucose control in people with type 2 diabetes. Br J Nutr 2008; 99(3):511-9.
11. Rech M E. Observations on the decay of glycated hemoglobin HbA1c in diabetic patients. Exp Clin Endocrinol Diabetes 1996; 104(2):102-5.
12. Yancy W S, Jr., Foy M, Chalecki A M, Vernon M C, Westman E C. A low-carbohydrate, ketogenic diet to treat type 2 diabetes. Nutr Metab (Lond) 2005; 2:34.
13. Nuttall F Q, Schweim K, Hoover H, Gannon M C. Metabolic effect of a LoBAG30 diet in men with type 2 diabetes. Am J Physiol Endocrinol Metab 2006; 291(4):E786-91.
14. Barzel U S, Massey L K. Excess dietary protein can adversely affect bone. J Nutr 1998; 128(6):1051-3.
15. Gannon M C: A computer program to calculate the rate of appearance of glucose in the peripheral circulation following infusion of labeled glucose. Copyright, University of Minnesota, Minneapolis, Minn. 1991.
16. Watson P E, Watson I D, Batt R D: Total body water volumes for adult males and females estimated from simple anthropometric measurements. Am J Clin Nutr 1980; 33:27-39.
17. Hamberg O, Vilstrup H: Effects of insulin and glucose on urea synthesis in normal man, independent of pancreatic hormone secretion. J Hepatol 1994; 21:381-387.
18. Unger R H, Orci L: Physiology and pathophysiology of glucagon. Physiol Rev 1976; 56:778-826.
19. Ahmed M, Nuttall F Q, Gannon M C, Lamusga R F: Plasma glucagon and alpha-amino acid nitrogen response to various diets in normal humans. Am J Clin Nutr 1980; 33:1917-1924.
20. Nuttall F Q, Ngo A, Gannon M C: Regulation of hepatic glucose production and the role of gluconeogenesis in humans: is the rate of gluconeogenesis constant? Diabetes Metab Res Rev 2008; 24:438-458.
21. Ahrens E H, Jr., Hirsch J, Oette K, Farquhar J W, Stein Y: Carbohydrate-induced and fat-induced lipemia. Trans Assoc Am Physicians 1961; 74:134-146.
22. Nuttall F Q, Gannon M C, Saeed A, Jordan K, Hoover H: The metabolic response of subjects with type 2 diabetes to a high-protein, weight-maintenance diet. J Clin Endocrinol Metab 2003; 88:3577-3583.
23. Nuttall F Q, Gannon M C: The metabolic response to a high-protein, low-carbohydrate diet in men with type 2 diabetes mellitus. Metabolism 2006; 55:243-251.
24. Bonjour J P: Dietary protein: an essential nutrient for bone health. J Am Coll Nutr 2005; 24:5265-5365.
25. Heaney R P: Protein intake and the calcium economy. J Am Diet Assoc 1993; 93:1259-1260.
26. Cooper C, Atkinson E J, Hensrud D D, Wahner H W, O'Fallon W M, Riggs B L, Melton L J, 3rd: Dietary protein intake and bone mass in women. Calcif Tissue Int 1996; 58:320-325.
27. Promislow J H, Goodman-Gruen D, Slymen D J, Barrett-Connor E: Protein consumption and bone mineral density in the elderly: the Rancho Bernardo Study. Am J Epidemiol 2002; 155:636-644.
28. Eastell R, Lambert H: Diet and healthy bones. Calcif Tissue Int 2002; 70:400-404.
29. Roughead Z K, Johnson L K, Lykken G I, Hunt JR: Controlled high meat diets do not affect calcium retention or indices of bone status in healthy postmenopausal women. J Nutr 2003; 133:1020-1026.
30. Wengreen H J, Munger R G, West N A, Cutler D R, Corcoran C D, Zhang J, Sassano N E: Dietary protein intake and risk of osteoporotic hip fracture in elderly residents of Utah. J Bone Miner Res 2004; 19:537-545.
31. Dawson-Hughes B, Harris S S, Rasmussen H, Song L, Dallal G E: Effect of dietary protein supplements on calcium excretion in healthy older men and women. J Clin Endocrinol Metab 2004; 89:1169-1173.
32. Rizzoli R, Bonjour J P: Dietary protein and bone health. J Bone Miner Res 2004; 19:527-531.
33. Accurso A, Bernstein R K, Dahlqvist A, Draznin B, Feinman R D, Fine E J, Gleed A, Jacobs D B, Larson G, Lustig R H, Manninen A H, McFarlane S I, Morrison K, Nielsen J V, Ravnskov U, Roth K S, Silvestre R, Sowers J R, Sundberg R, Volek J S, Westman E C, Wood R J, Wortman J, Vernon M C: Dietary carbohydrate restriction in type 2 diabetes mellitus and metabolic syndrome: time for a critical appraisal. Nutr Metab (Lond) 2008; 5:9.
34. Westman E C, Yancy W S, Jr., Mavropoulos J C, Marquart M, McDuffie J R: The effect of a low-carbohydrate, ketogenic diet versus a low-glycemic index diet on glycemic control in type 2 diabetes mellitus. Nutr Metab (Lond) 2008; 5:36.
35. Allick G, Bisschop P H, Ackermans M T, Endert E, Meijer A J, Kuipers F, Sauerwein H P, Romijn J A: A low-carbohydrate/high-fat diet improves glucoregulation in type 2 diabetes mellitus by reducing postabsorptive glycogenolysis. J Clin Endocrinol Metab 2004; 89:6193-6197.
36. Sharman M J, Kraemer W J, Love D M, Avery N G, Gomez A L, Scheett T P, Volek J S: A ketogenic diet favorably affects serum biomarkers for cardiovascular disease in normal-weight men. J Nutr 2002; 132:1879-1885.

What is claimed is:

1. A method of reducing glycohemoglobin and fasting glucose levels in an individual, comprising:
providing an article of manufacture, wherein the article of manufacture comprises food items for a single day, wherein the food items have a nutritional composition that consists essentially of 30% protein, 40% fats, and 30% carbohydrates, and
having the individual consume the food items each day for a period of five to ten weeks to significantly reduce the levels of glycohemoglobin and fasting glucose in the individual.

2. The method of claim 1, wherein ingestion of the food items does not result in ketosis in the individual.

3. The method of claim 1, wherein ingestion of the food items results in maintenance of the individual's weight.

4. The method of claim 1, wherein ingestion of the food items does not result in the individual losing weight.

5. The method of claim 1, wherein the step of having the individual consume the food items comprises providing instructions to the individual.

6. The method of claim 5, wherein the instructions are provided online.

7. The method of claim 5, wherein the instructions comprise written instructions accompanying the article of manufacture.

8. The method of claim 1, wherein the individual has type 2 diabetes.

9. A method of reducing glycohemoglobin and fasting glucose levels in an individual, comprising:
providing an article of manufacture, wherein the article of manufacture comprises food items for a single day, wherein the food items have a nutritional composition that consists essentially of 30% protein, 40% fats, and 30% carbohydrates, and
having the individual consume the food items each day for a period of nine weeks to one year to significantly reduce the levels of glycohemoglobin and fasting glucose in the individual.

10. The method of claim 9, wherein ingestion of the food items does not result in ketosis in the individual.

11. The method of claim 9, wherein ingestion of the food items results in maintenance of the individual's weight.

12. The method of claim 9, wherein ingestion of the food items does not result in the individual losing weight.

13. The method of claim 9, wherein the step of having the individual consume the food items comprises providing instructions to the individual.

14. The method of claim 13, wherein the instructions are provided online.

15. The method of claim 13, wherein the instructions comprise written instructions accompanying the article of manufacture.

16. The method of claim 9, wherein the individual has type 2 diabetes.

17. The method of claim 9, wherein the period of having the individual consume the food items comprises nine to twenty weeks.

18. The method of claim 9, wherein the period of having the individual consume the food items comprises fifteen weeks.
